(19) United States
(12) Patent Application Publication
(10) Pub. No.: US 2013/0168458 A1
(43) Pub. Date: Jul. 4, 2013

(54) VEHICLE AIR CONDITIONER

(71) Applicants: Yoshinori Ichishi, Kariya-city (JP); Yasushi Kondo, Aichi-gun (JP); Yoshinori Kumamoto, Takahama-city (JP); Yoshinori Yanagimachi, Takahama-city (JP); Seiji Tanaka, Toyota-city (JP); Takaaki Goto, Seto-city (JP)

(72) Inventors: Yoshinori Ichishi, Kariya-city (JP); Yasushi Kondo, Aichi-gun (JP); Yoshinori Kumamoto, Takahama-city (JP); Yoshinori Yanagimachi, Takahama-city (JP); Seiji Tanaka, Toyota-city (JP); Takaaki Goto, Seto-city (JP)

(73) Assignees: TOYOTA JIDOSHA KABUSHIKI KAISHA, Toyota-shi, Aichi-ken (JP); DENSO CORPORATION, Kariya-city, Aichi-pref. (JP)

(21) Appl. No.: 13/822,185

(22) PCT Filed: Sep. 5, 2011
(86) PCT No.: PCT/JP2011/004950

§ 371 Date: Mar. 11, 2013

(30) Foreign Application Priority Data
Sep. 30, 2010 (JP) 2010-221545

(51) Int. Cl. B60H 1/02

(52) U.S. Cl. CPC B60H 1/02
USPC 237/2 A; 237/12.3 A

(57) ABSTRACT

An air conditioner is applied to a vehicle having a first operation mode in which an internal combustion engine-side driving force is more than a motor-side driving force, and a second operation mode in which the motor-side driving force is more than the internal combustion engine-side driving force, as an operation mode for the vehicle. The air conditioner includes a heater for heating air using a coolant of an internal combustion engine as a heat source, and a request signal output portion for outputting a request signal for increasing the number of revolutions of the internal combustion engine to a driving force controller during a heating operation of the vehicle interior. The request signal output portion outputs as the request signal, a signal that makes the number of revolutions increased in the second operation mode higher than that increased in the first operation mode.

### CROSS REFERENCE TO RELATED APPLICATION

This application is based on Japanese Patent Application No. 2010-221545 filed on Sep. 30, 2010, the contents of which are incorporated herein by reference in its entirety.

### FIELD OF THE INVENTION

The present invention relates to a vehicle air conditioner for heating air to be blown into an interior of a vehicle by using an engine coolant as a heat source.

### BACKGROUND OF THE INVENTION

Hybrid cars have been hithereto known which are designed to obtain a driving force for traveling both from an engine (internal combustion engine) and from an electric motor for traveling. Patent Document 1 discloses a vehicle air conditioner which is applied to such a hybrid car. The air conditioner disclosed in the above Patent Document 1 is designed to heat air to be blown into an interior of the vehicle using a coolant for cooling an engine as a heat source during a heating operation for heating the interior of the vehicle.

This type of hybrid car sometimes stops the engine in order to improve the fuel efficiency of the vehicle even in stopping or traveling of the vehicle. In this case, when the vehicle air conditioner performs heating of the vehicle interior, the temperature of coolant is not increased to a sufficient temperature for a heating source for heating.

In the vehicle air conditioner disclosed in the above Patent Document 1, even under traveling conditions not requiring the operation of the engine for outputting the traveling driving force, when the temperature of the coolant is not increased to a sufficient level for the heat source for heating, an operation request signal for the engine is output to a driving force controller so as to increase the temperature of the coolant up to the sufficient level for the heat source for heating.

### PRIOR ART DOCUMENT

### Patent Document

Patent Document 1: Japanese Unexamined Patent Publication No. 2008-174042

The recent hybrid vehicles include the so-called plug-in hybrid vehicle which can charge a battery mounted on a vehicle using an external power supply (commercial power supply) when the vehicle stops.

Such a plug-in hybrid vehicle is operated in the following way by charging the battery with the external heat source while the vehicle is stopping. When a remaining level of the battery is equal to or more than a predetermined reference remaining level for traveling, like in start-up of the vehicle, the hybrid vehicle is operated in an EV operation mode for obtaining a driving force for traveling mainly from the electric motor for traveling. When a remaining level of the battery is lower than the reference remaining level for traveling, the hybrid vehicle is operated in an HV operation mode for obtaining a driving force for traveling mainly from the engine.

More specifically, the EV operation mode is an operation mode in which the vehicle is traveled by the driving force output mainly from the electric motor for traveling, and when a traveling load on the vehicle becomes high, the engine is operated to assist the electric motor for traveling. Thus, in the EV operation mode, a ratio of the driving force output from the electric motor for traveling to the driving force output from the engine becomes large.

In contrast, the HV operation mode is an operation mode in which the vehicle is traveled by the driving force output mainly from the engine, and when a traveling load on the vehicle becomes high, the electric motor for traveling is operated to assist the engine. Thus, in the HV operation mode, the above driving force ratio becomes small.

When the vehicle air conditioner disclosed in the Patent Document 1 is applied to the plug-in hybrid vehicle, in the EV operation mode the engine is intended to be operated so as to increase the temperature of coolant up to the sufficient level for the heat source for heating. However, in the EV operation mode, the driving force ratio is inherently large to make the output from the engine smaller, and thereby it cannot increase the temperature of the coolant up to the sufficient level for the heat source for heating in some cases.

As a result, even when the vehicle air conditioner disclosed in the above Patent Document 1 is applied to the plug-in hybrid vehicle, the air blown into the vehicle interior cannot be heated enough, and thereby it is difficult to achieve the sufficient heating operation.

### SUMMARY OF THE INVENTION

In view of the forgoing points, it is an object of the present invention to achieve a sufficient heating operation of a vehicle air conditioner to be applied to a plug-in hybrid vehicle with an operation mode in which a driving force output from an internal combustion engine is more than that output from an electric motor for traveling.

An air conditioner according to one aspect of the invention is applied to a vehicle including an electric motor for traveling and an internal combustion engine, as a driving source for outputting a driving force for traveling of the vehicle. Further, the air conditioner is applied to the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as the operation mode for the vehicle. The vehicle air conditioner includes a heater for heating air blown into a vehicle interior using a coolant of the internal combustion engine as a heat source, and a request signal output device for outputting a request signal for increasing the number of revolutions of the internal combustion engine, to a driving force controller for controlling an operation of the internal combustion engine, during a heating operation of the vehicle interior. The request signal output device outputs as the request signal, a signal that makes the number of revolutions increased in the second operation mode higher than that increased in the first operation mode.

With this arrangement, although in the second operation mode, the motor-side driving force is more than the internal combustion engine-side driving force and the coolant temperature is less likely to increase in the heating operation of the vehicle interior, the request signal output device outputs the request signal that makes the number of revolutions increased in the second operation mode higher than that increased in the first operation mode. Thus, even in the second operation mode, the coolant temperature can be increased up to the sufficient level for the heat source for heating. As a result, the air blown into the vehicle interior can be sufficiently heated by the heater, and thereby it can achieve the sufficient heating of the vehicle interior.

For example, the vehicle air conditioner may further include an outside air temperature detection device for detecting an outside air temperature of the vehicle. Furthermore, the request signal output device may output as the request signal, a signal that increases the number of revolutions with decreasing outside air temperature. When a high heating capacity is required, for example, at a low outside air temperature, the heater can exhibit the high heating capacity. Further, when the outside air temperature is relatively high, the increase in number of revolutions can be reduced to achieve the energy saving of the internal combustion engine.

The vehicle air conditioner further includes a target temperature setting portion for setting a target temperature of the vehicle interior by an operation of a passenger. Furthermore, the request signal output device may output as the request signal, a signal that increases the number of revolutions of the internal combustion engine with increasing target temperature. In this case, when the high vehicle interior temperature is required by the passenger, the heater can exhibit the high heating capacity. When the relatively low vehicle interior temperature is required by the passenger, the increase in number of revolutions can be reduced to achieve the energy saving of the internal combustion engine.

The vehicle air conditioner may further include an auxiliary heater for increasing the temperature of at least a part of the vehicle interior. And the request signal output device may output as the request signal, a signal that increases the number of revolutions when the auxiliary heater is operating, as compared to when the auxiliary heater is not operating. In this case, when the high heating capacity is required, for example, when the warm feeling of the passenger is assisted by the auxiliary heater, the heater can exhibit the high heating capacity.

The vehicle air conditioner may further include an energy saving request device for outputting an energy saving request signal for requesting energy saving of power requested for air conditioning of the vehicle interior by an operation of the passenger. Furthermore, the request signal output device may output as the request signal, a signal that decreases the number of revolutions when the energy saving request device is turned on, as compared to when the energy saving request device is turned off. When the energy saving is required by the passenger, the air conditioner can achieve the energy saving of the internal combustion engine. Passengers who are very eager to save energy do not feel uncomfortable to a slight decrease in heating capacity.

An air conditioner according to another aspect of the invention is applied to a vehicle including an electric motor for traveling and an internal combustion engine as a driving source for outputting a driving force for traveling of the vehicle. Further, the vehicle air conditioner is applied to the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as the operation mode for the vehicle. The vehicle air conditioner includes a heater for heating air blown into a vehicle interior using a coolant of the internal combustion engine as a heat source, and a request signal output device for outputting a request signal for decreasing a driving force ratio of the internal combustion engine-side driving force to the motor-side driving force, to a driving force controller for controlling operations of the internal combustion engine and the electric motor for traveling, when a heating operation of the vehicle interior is performed in the second operation mode.

With this arrangement, when the heating operation of the vehicle interior is performed, the request signal output device outputs the request signal that decreases the driving force ratio in the second operation mode in which the driving force ratio is small and the coolant temperature is less likely to increase as compared to in the first operation mode. At this time, in order not to change the driving force for traveling, the driving force controller increases the internal combustion engine-side driving force, so that even in the second operation mode, the coolant temperature can be increased to the sufficient level for the heat source for heating. As a result, the heater can sufficiently heat the air blown into the vehicle interior, and thereby it can achieve the sufficient warming of the vehicle interior.

The vehicle air conditioner may further include an outside air temperature detection device for detecting the outside air temperature. Furthermore, the request signal output device may output as the request signal, a signal that decreases the driving force ratio with decreasing outside air temperature. In this case, since the motor-side driving force is reduced, the driving force controller can increase the internal combustion engine-side driving force. Thus, when the high heating capacity is required, for example, at a low outside air temperature, the heater can sufficiently exhibit the high heating capacity. When the outside air temperature is relatively high, the decrease in driving force ratio can be reduced, and thereby it can achieve the energy saving of the internal combustion engine.

The vehicle air conditioner may further include a target temperature setting portion for setting a target temperature of the vehicle interior by an operation of a passenger. Furthermore, the request signal output device may output as the request signal, a signal that decreases the driving force ratio with increasing target temperature. In this case, the motor-side driving force can be increased, and thus the driving force controller can increase the internal combustion engine-side driving force. Thus, when the high temperature of the vehicle interior is required by the passenger, the heater can exhibit the high heating capacity. When the relatively low vehicle interior temperature is required by the passenger, the energy saving of the internal combustion engine can be achieved.

The vehicle air conditioner may further include an auxiliary heater for increasing the temperature of at least a part of the vehicle interior. Furthermore, the request signal output device may output as the request signal, a signal that decreases the driving force ratio when the auxiliary heater is operating, as compared to when the auxiliary heater is not operating. Thus, the driving force controller increases the internal combustion engine-side driving force. When the high heating capacity is required, for example, when the warm feeling of the passenger is assisted by the auxiliary heater, the heater can exhibit the high heating capacity.

The vehicle air conditioner may further include an energy saving request device for outputting an energy saving request signal for requesting energy saving of power requested for air conditioning of the vehicle interior by an operation of the passenger. Furthermore, the request signal output device may output as the request signal, a signal that increases the driving force ratio when the energy saving request device is turned on, as compared to when the energy saving request device is turned off. As a result, the driving force controller cannot increase the internal combustion engine-side driving force. Thus, when the energy saving is required by the passenger, the energy saving of the internal combustion engine can be achieved. Further, passengers who are very eager to save energy do not feel uncomfortable to a slight decrease in heating capacity.

An air conditioner according to a further aspect of the invention is applied to a vehicle including an electric motor for traveling and an internal combustion engine as a driving source for outputting a driving force for traveling of the vehicle. The vehicle air conditioner is applied to the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as the operation mode for the vehicle. The vehicle air conditioner includes a heater for heating air blown into a vehicle interior using a coolant of the internal combustion engine as a heat source, and a request signal output device for outputting a request signal for requesting a driving force controller to switch the operation into the first operation mode when a predetermined condition is satisfied during heating the vehicle interior in the second operation mode. The driving force controller is adapted to control operations of the internal combustion engine and the electric motor for traveling.

Thus, when the predetermined condition is satisfied in a heating operation of the vehicle interior, the request signal output device causes the driving force controller for controlling the operation of the internal combustion engine and the electric motor for traveling to perform switching into the first operation mode in which the internal combustion engine-side driving force is more than the motor-side driving force, so that the coolant temperature can be increased up to the sufficient level for the heat source for heating. As a result, the air blown into the vehicle interior can be sufficiently heated by the heater, and thereby it can achieve the sufficient heating of the vehicle interior.

The predetermined condition is a condition where a high heating capacity is required for the vehicle air conditioner. For example, the vehicle air conditioner may further include an outside air temperature detection device for detecting the outside air temperature. Furthermore, the predetermined condition may be determined to be satisfied when the outside air temperature is equal to or less than the predetermined reference outside air temperature. Alternatively, the vehicle air conditioner may further include a target temperature setting portion for setting a target temperature of the vehicle interior by an operation of the passenger. Furthermore, the predetermined condition may be determined to be satisfied when the target temperature is equal to or more than the predetermined reference target temperature.

Alternatively, the vehicle air conditioner may further include an auxiliary heater for increasing the temperature of at least a part of a vehicle interior. Furthermore, the predetermined condition may be determined to be satisfied when the auxiliary heater is operating. Otherwise, the vehicle air conditioner may further include an energy saving request device for outputting an energy saving request signal for requesting energy saving of power requested for air conditioning of the vehicle interior by an operation of the passenger. The predetermined condition may be determined to be satisfied when the energy saving request is not required by the energy saving request device.

The predetermined condition may be a condition where the high antifogging capacity is required for the vehicle air conditioner. For example, the vehicle air conditioner may further include a humidity detection device for detecting a humidity near a windshield of the vehicle. And the predetermined condition may be determined to be satisfied when the humidity detected by the humidity detection device is equal to or more than the predetermined reference humidity.

Alternatively, the vehicle air conditioner may further include an air outlet mode switching portion for switching between a plurality of air outlet modes by changing a ratio of volumes of air blown from a plurality of air outlets between the air outlets, the air outlets including at least a defroster air outlet for blowing the air toward the windshield of the vehicle. Furthermore, the predetermined condition may be determined to be satisfied when the air outlet mode switching portion performs switching into the defroster mode for blowing out the air from the defroster air outlet.

For example, the auxiliary heater may be a seat heater for increasing the temperature of a seat where the passenger sits, or windshield heating device for heating the windshield of the vehicle.

### BRIEF DESCRIPTION OF DRAWINGS

FIG. 1 is an entire configuration diagram of a vehicle air conditioner according to a first embodiment;

FIG. 2 is a block diagram showing an electric controller of the vehicle air conditioner in the first embodiment;

FIG. 3 is a circuit diagram of a PTC heater in the first embodiment;

FIG. 4 is a flowchart showing a control process performed by the vehicle air conditioner of the first embodiment;

FIG. 5 is a flowchart showing a part of the control process performed by the vehicle air conditioner of the first embodiment;

FIG. 6 is a flowchart showing another part of the control process performed by the vehicle air conditioner of the first embodiment;

FIG. 7 is a flowchart showing another part of the control process performed by the vehicle air conditioner of the first embodiment;

FIG. 8 is a flowchart showing another part of the control process performed by the vehicle air conditioner of the first embodiment;

FIG. 9 is a diagram showing determination of operation modes in the first embodiment;

FIG. 10 is a flowchart showing a control process performed by a vehicle air conditioner of a second embodiment;

FIG. 11 is a flowchart showing another part of the control process performed by the vehicle air conditioner of the second embodiment;

FIG. 12 is a flowchart showing a part of a control process performed by a vehicle air conditioner of a third embodiment; and

FIG. 13 is a flowchart showing a part of a control process performed by a vehicle air conditioner of a fourth embodiment.

### BEST MODE FOR CARRYING OUT THE INVENTION

### First Embodiment

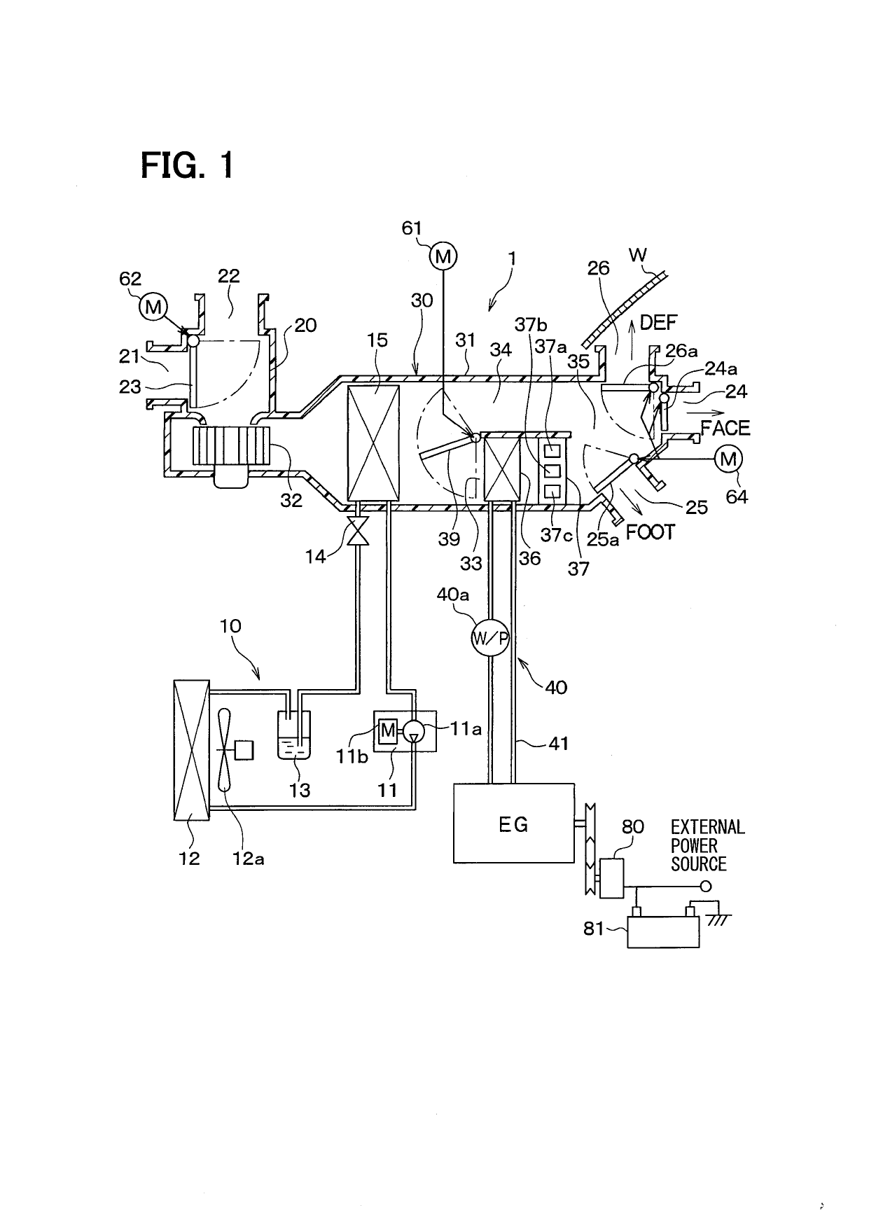

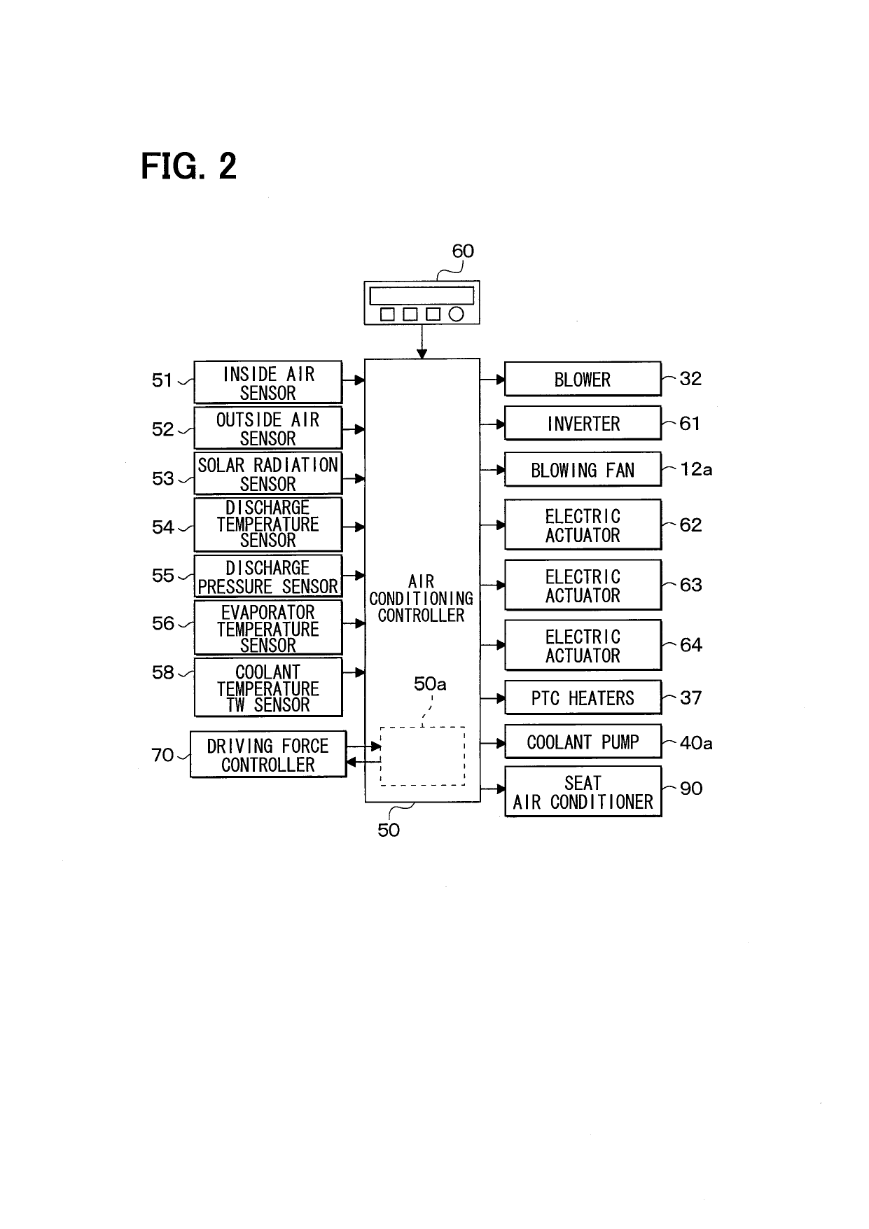

A first embodiment of the present invention will be described below with reference to FIGS. 1 to 9. FIG. 1 shows an entire configuration diagram of a vehicle air conditioner 1 in this embodiment. FIG. 2 shows a block diagram of an electric controller of the vehicle air conditioner 1. In this embodiment, the vehicle air conditioner 1 is applied to a hybrid vehicle that obtains the driving force from an internal combustion engine (engine) EG and an electric motor for traveling.

The hybrid vehicle in this embodiment is comprised of a plug-in hybrid vehicle that can charge a battery 81 with electric power supplied from an external power supply (commercial power supply) while the vehicle is stopping.

The plug-in hybrid vehicle charges the battery 81 with the power from the external power supply while the vehicle is stopping before start-up of the vehicle. When the remaining storage level SOC of the battery 81 is equal to or more than the predetermined reference remaining level for traveling, for example, at the start-up of the vehicle, the vehicle is switched into an operation mode for causing the vehicle to travel by use of the driving force mainly from the electric motor for traveling. The operation mode is hereinafter referred to as an EV operation mode. In this embodiment, the EV operation mode corresponds to a second operation mode.

When the remaining storage level SOC of the battery 81 is lower than the reference remaining level for traveling while the vehicle is traveling, the vehicle is switched into another operation mode for causing the vehicle to travel by use of the driving force mainly from the engine EG. This operation mode is hereinafter referred to as an HV operation mode. In this embodiment, the HV operation mode corresponds to a first operation mode.

More specifically, the EV operation mode is the operation mode in which the vehicle is traveled by the driving force output mainly from the electric motor for traveling. When the traveling load on the vehicle becomes high, the engine EG is operated to assist the electric motor for traveling. That is, the EV operation mode is the operation mode in which the driving force (motor side driving force) for traveling output from the electric motor for traveling becomes larger than the driving force (internal combustion engine-side driving force) for traveling output from the engine EG.

In other words, the EV operation mode can be defined as the operation mode in which the ratio of the motor-side driving force to the internal combustion engine-side driving force (motor-side driving force/international combustion engine-side driving force) is larger than at least 0.5.

In contrast, the HV operation mode is the operation mode in which the vehicle is traveled by the driving force output mainly from the engine EG. When the traveling load on the vehicle becomes high, the electric motor for traveling is operated to assist the engine EG. That is, the HV operation mode is the operation mode in which the internal combustion engine-side driving force becomes larger than the motor-side driving force. In other words, the HV operation mode can be defined as the operation mode in which the driving force ratio (motor-side driving force/internal combustion engine-side driving force) can be smaller than at least 0.5.

The plug-in hybrid vehicle of this embodiment performs switching between the EV operation mode and the HV operation mode to thereby suppress the fuel consumption of the engine EG as compared to a normal vehicle that can obtain the driving force for traveling only from the engine EG, so as to lead to improvement of the fuel efficiency of the vehicle. The switching between the EV operation mode and the HV operation mode, and the control of the driving force ratio are performed by a driving force controller 70 to be described later.

The driving force output from the engine EG is used not only for traveling of the vehicle, but also for operating a power generator 80. The electric power generated by the generator 80 and the power supplied from the external power supply can be stored in the battery 81. The power stored in the battery 81 can be supplied to various types of vehicle-mounted devices, including an electric device forming the vehicle air conditioner 1, in addition to the electric motor for traveling.

Next, the detailed structure of the vehicle air conditioner 1 of this embodiment will be described below. The vehicle air conditioner 1 of this embodiment includes a refrigeration cycle 10 shown in FIG. 1, an indoor air conditioning unit 30, an air conditioning controller 50 shown in FIG. 2, a seat air conditioner 90, and the like. The indoor air conditioning unit 30 is disposed on the inner side of a gauge board (instrument panel) at the foremost part of the vehicle compartment, and accommodates a blower 32, an evaporator 15, a heater core 36, a PTC heater 37, and the like in a casing 31 forming an outer shell of the unit 30.

The casing 31 forms an air passage of the air blown into the vehicle interior and is formed of resin with adequate elasticity and excellent strength (for example, polypropylene). An inside/outside air switching box 20 is provided as inside/outside air switching device for switching between inside air (indoor air) and outside air (outdoor air), on the most upstream side of the air flow inside the casing 31.

More specifically, the inside/outside air switching box 20 is provided with an inside air inlet 21 for introducing the inside air into the casing 31, and an outside air inlet 22 for introducing the outside air thereinto. An inside/outside air switching door 23 is disposed inside the inside/outside air switching box 20. The switching door continuously adjusts opening areas of the inside air inlet 21 and the outside air inlet 22 to thereby change a ratio of the volume of inside air to that of outside air introduced into the casing 31.

The inside/outside air switching door 23 serves as an air volume ratio changing device for switching between suction port modes to change the ratio of the volume of inside air to that of the outside air introduced into the casing 31. More specifically, the inside/outside air switching door 23 is driven by an electric actuator 62 for the inside/outside air switching door 23. The electric actuator 62 has its operation controlled by a control signal output from the air conditioning controller 50 to be described later.

The suction port modes include an inside air mode for introducing the inside air into the casing 31 by fully opening the inside air inlet 21 and completely closing the outside air inlet 22, an outside air mode for introducing the outside air into the casing 31 by completely closing the inside air inlet 21 and fully opening the outside air inlet 22, and an inside/outside air mixing mode for continuously changing the ratio of introduction of the inside air to the outside air by continuously adjusting the opening areas of the inside air inlet 21 and the outside air inlet 22 between the inside air mode and the outside air mode.

The air blower (blower) 32 is provided on the downstream side of the air flow of the inside/outside air switching box 20, and serves as a blowing device for blowing the air sucked via the inside/outside air switching box 20 into the vehicle interior. The blower 32 is an electric blower which drives a centrifugal multiblade fan (sirrocco fan) by use of an electric motor. The blower 32 has its number of revolutions (volume of air) controlled by a control voltage output from the air conditioning controller 50. The electric motor serves as a blowing capacity changing device of the blower 32.

An evaporator 15 is disposed on the downstream side of the air flow from the blower 32. The evaporator 15 serves as a heat exchanger for cooling that exchanges heat between a refrigerant flowing therethrough and the air from the blower 32 to thereby cool the air. Specifically, the evaporator 15 forms the vapor compression refrigeration cycle 10 together with a compressor 11, a condenser 12, a gas-liquid separator 13, and an expansion valve 14.

The compressor 11 is positioned in an engine room, and is to suck, compress, and discharge the refrigerant in the refrigeration cycle 10. The compressor is an electric compressor which drives a fixed displacement compression mechanism 11a with a fixed discharge capacity by use of an electric motor 11b. The electric motor 11b is an AC motor whose operation (number of revolutions) is controlled by an AC voltage output from an inverter 61.

The inverter 61 outputs an AC voltage at a frequency in response to the control signal output from the air conditioning controller 50 to be described later. By the control of the number of revolutions, the refrigerant discharge capacity of the compressor 11 is changed. Thus, the electric motor 11b serves as the discharge capacity changing device of the compressor 11.

The condenser 12 is an outdoor heat exchanger which is disposed in a bonnet, and which serves to condense the refrigerant discharged from the compressor 11 by exchanging heat between the refrigerant flowing therethrough and an outdoor air (outside air) blown from a blowing fan 12a as the outdoor blower. The blowing fan 12a is an electric blower whose operating ratio or number of revolutions (volume of air) is controlled by a control voltage output from the air conditioning controller 50.

The gas-liquid separator 13 is a receiver which separates the refrigerant condensed by the condenser 12 into liquid and gas phases to store therein the excessive refrigerant, and which allows only the separated liquid-phase refrigerant to flow toward the downstream side. The expansion valve 14 is a decompression device for decompressing and expanding the liquid-phase refrigerant flowing from the gas-liquid separator 13. The evaporator 15 is an indoor heat exchanger for evaporating the refrigerant decompressed and expanded by the expansion valve 14 to exhibit the heat absorption effect for the refrigerant. Thus, the evaporator 15 serves as a heat exchanger for cooling that cools the air.

In the casing 31, air passages for flowing air having passed through the evaporator 15, including a cool air passage 33 for heating and a cool air bypass passage 34, and a mixing space 35 for mixing the air flowing from the passages 33 and 34 are formed on the downstream side of the air flow of the evaporator 15.

A heater core 36 and a PTC heater 37 for heating air having passed through the evaporator 15 are disposed toward the flow direction of the air in that order in the cool air passage 33 for heating. The heater core 36 is a heat exchanger for heating that exchanges heat between an engine coolant (hereinafter simply referred to as a “coolant”) for cooling the engine EG and the air passing through the evaporator 15 to thereby heat the air having passed through the evaporator 15.

Specifically, the heater core 36 and the engine EG are connected together by coolant pipes to thereby form a coolant circuit 40 for circulating a coolant between the heater core 36 and the engine EG. The coolant circuit 40 is provided with a coolant pump 40a for circulating the coolant. The coolant pump 40a is an electric water pump whose number of revolutions (flow rate of the circulating coolant) is controlled by a control voltage output from the air conditioning controller 50.

The PTC heater 37 is an electric heater with a PTC element (positive characteristic thermistor), and serves as an auxiliary heater for heating air passing through the heater core 36 with heat generated by supplying electric power to the PTC element. The power consumption required to operate the PTC heater 37 of this embodiment is smaller than that required to operate the compressor 11 of the refrigeration cycle 10.

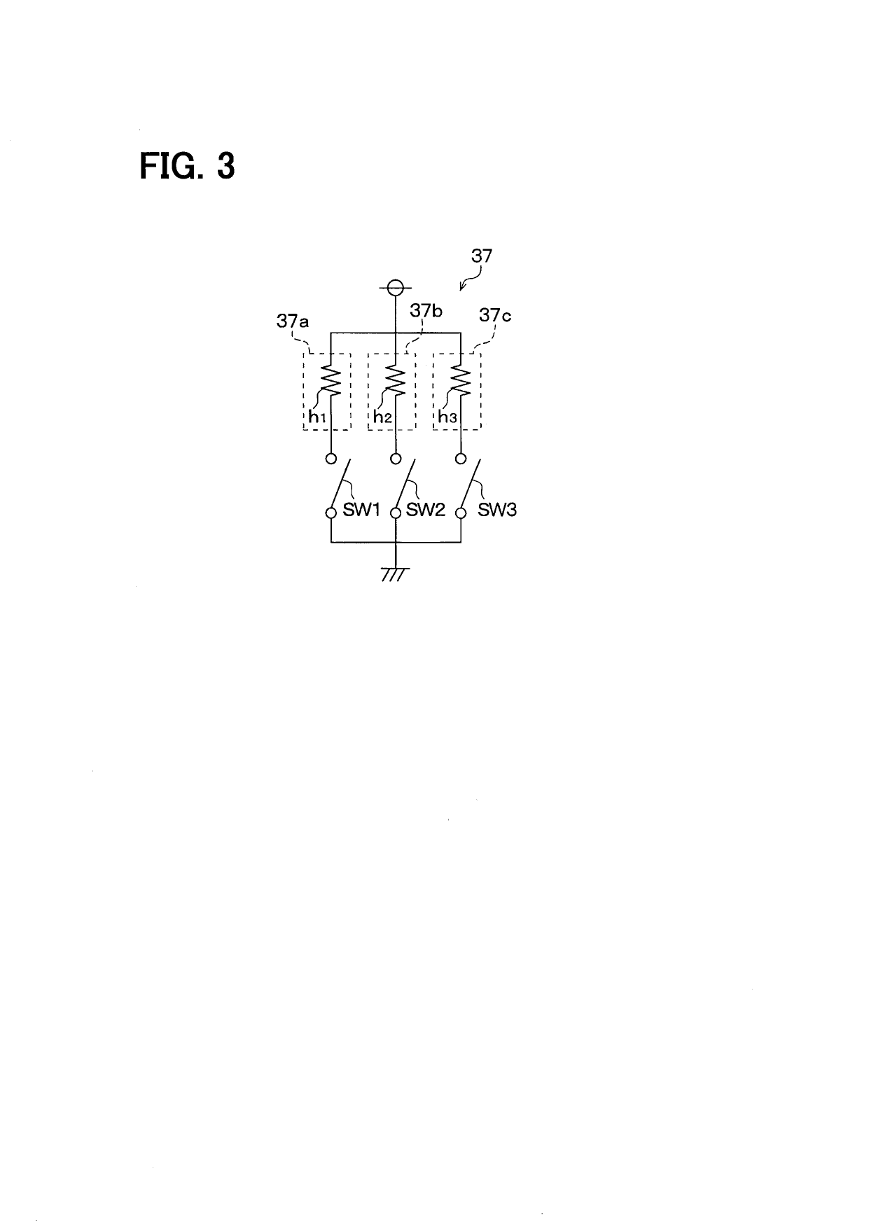

More specifically, as shown in FIG. 3, the PTC heater 37 is comprised of a plurality of (in this embodiment, three) PTC heaters 37a, 37b, and 37c. FIG. 3 shows a circuit diagram of electric connection of the PTC heaters 37 in this embodiment.

As shown in FIG. 3, the positive side of each of the PTC heaters 37a, 37b, and 37c is connected to the battery 81 side, and the negative side thereof is connected to the ground via each of switch elements SW1, SW2, and SW3 included in the PTC heaters 37a, 37b, and 37c. The respective switch elements SW1, SW2, and SW3 switch between an energization state (ON state) and a non-energization state (OFF state) of each of the PTC elements h1, h2, and h3 included in the PTC heaters 37a, 37b, and 37c.

The operations of the respective switch elements SW1, SW2, and SW3 are independently controlled by control signals output from the air conditioning controller 50. Thus, the air conditioning controller 50 independently switches between the energization and non-energization of each of the switch elements SW1, SW2, and SW3 to perform switching among the PTC heaters 37a, 37b, and 37c to exhibit the heating capacity of the corresponding PTC heater in the energization state, and thereby it can change the heating capacity of the entire PTC heater 37.

The cool air bypass passage 34 is an air passage for leading the air having passed through the evaporator 15 to the mixing space 35 without allowing the air to pass through the heater core 36 and the PTC heater 37. Thus, the temperature of the air mixed in the mixing space 35 is changed according to a ratio of volume of the air passing through the cooling passage 33 for heating to that of the air passing through the cool air bypass passage 34.

In this embodiment, an air mix door 39 is disposed on the downstream side of the air flow of the evaporator 15, and on the inlet sides of the cool air passage 33 for heating and the cool air bypass passage 34. The air mix door 39 is adapted to continuously change the ratio of volume of the cool air into the cool air passage 33 for heating to that of the cool air into the cool air bypass passage 34.

Thus, the air mix door 39 serves as a temperature adjustment device for adjusting the temperature of air in the mixing space 35 (temperature of air blown into the vehicle interior). More specifically, the air mix door 39 is driven by an electric actuator 63 for the air mix door. The electric actuator 63 has its operation controlled by a control signal output from the air conditioning controller 50.

Air outlets 24 to 26 for blowing the air whose temperature is adjusted, from the mixing space 35 into the vehicle interior as a space of interest to be conditioned are disposed on the most downstream side of the air flow in the casing 31. Specifically, the air outlets 24 to 26 include a face air outlet 24 from which the conditioned air is blown toward an upper body of a passenger in the vehicle compartment, a foot air outlet 25 from which the conditioned air is blown toward a foot of the passenger, and a defroster air outlet 26 from which the conditioned air is blown toward the inner side of a front windshield of the vehicle.

The face air outlet 24, the foot air outlet 25, and the defroster air outlet 26 have, at the respective upstream sides of the air flow thereof, a face door 24a for adjusting an opening area of the face air outlet 24, a foot door 25a for adjusting an opening area of the foot air outlet 25, and a defroster door 26a for adjusting an opening area of the defroster air outlet 26, respectively.

The face door 24a, the foot door 25a, and the defroster door 26a serve as air outlet mode switching portion for switching among air outlet modes, and are coupled to and rotated by an electric actuator 64 for driving of the air outlet mode doors via a link mechanism (not shown). The electric actuator 64 also has its operation controlled by a control signal output from the air conditioning controller 50.

The air outlet modes include a face mode for blowing out air from the face air outlet 24 toward the upper half of the passenger in the vehicle compartment by fully opening the face air outlet 24, and a bi-level mode for blowing out air toward the upper half and foot of the passenger in the vehicle compartment by opening both the face air outlet 24 and the foot air outlet 26. The air outlet modes also include a foot mode for blowing out air mainly from the foot air outlet 25 by fully opening the foot air outlet 25 and slightly opening the defroster air outlet 26, and a foot defroster mode for blowing out air from both the foot air outlet 25 and the defroster air outlet 26 by opening both the foot air outlet 25 and the defroster air outlet 26 to the same degree.

Further, a switch of an operation panel 60 to be described later can also be manually operated by the passenger to fully open the defroster air outlet, bringing the air conditioner into a defroster mode for blowing out the air from the defroster air outlet into the inner surface of the front windshield of the vehicle.

The vehicle air conditioner 1 of this embodiment includes an electric defogger (not shown). The electric defogger is a heating wire placed inside or on the surface of the windshield in the vehicle compartment, and serves as a windshield heating device for antifogging or defrosting the window by heating the windshield. The electric defogger also has its operation controllable by a control signal output from the air conditioning controller 50.

Further, the vehicle air conditioner 1 of this embodiment includes a seat air conditioner 90 serving as an auxiliary heater for increasing the temperature of the surface of a seat where the passenger sits. Specifically, the seat air conditioner 90 is comprised of a heating wire embedded in the surface of the seat, and thus is a seat heater for generating heat by being supplied with power.

When the conditioned air blown from the air outlets 24 to 26 of the indoor air conditioning unit 10 cannot make the vehicle interior warm enough for the passenger, the seat air conditioner 90 works to compensate for the insufficient heating. The seat air conditioner 90 has its operation controlled by a control signal output from the air conditioning controller 50. In operation, the seat air conditioner 90 is controlled such that the temperature of the surface of the seat is increased to about 40° C.

Next, the electric controller of this embodiment will be described with reference to FIG. 2. The air conditioning controller 50 and the driving force controller 70 each are comprised of the well-known microcomputers, such as CPU, ROM, and RAM, and peripheral circuits thereof, and perform various types of computation and processing based on an air conditioning control program stored in the ROM to thereby control the operation of each component connected to the output side.

The output side of the driving force controller 70 is connected to an inverter for traveling or the like for supplying the AC current to various components of the engine EG and the electric motor for traveling. Various components of the engine include, specifically, a starter for starting up the engine EG, and a driving circuit (both not shown) for a fuel injection valve (injector) for supplying fuel to the engine EG.

A group of various sensors for control of the engine is coupled to the input side of the driving force controller 70. The sensors include a voltmeter for detecting an terminal-terminal voltage VB of a battery 81, an ammeter for detecting a current ABin flowing into the battery 81 or a current ABiout flowing from the battery 81, an accelerator opening degree sensor for detecting an accelerator opening degree Acc, an engine speed sensor for detecting the number of revolutions Ne of the engine, and a vehicle speed sensor for detecting the vehicle speed Vv (all sensors not shown in the figure).

Various components are connected to the output side of the air conditioning controller 50. The components include the blower 32, the inverter 61 for the electric motor 11b of the compressor 11, the blowing fan 12a, various electric actuators 62, 63, and 64, first to third PTC heaters 37a, 37b, and 37c, a coolant pump 40a, the seat air conditioner 90, and the like.

Another group of various sensors for control of air conditioning is coupled to the input side of the air conditioning controller 50. The sensors include an inside air sensor 51 for detecting a temperature Tr of the vehicle interior, an outside air sensor 52 (outside air temperature detection device) for detecting a temperature Tam of the outside air, and a solar radiation sensor 53 for detecting an amount of solar radiation Ts in the vehicle interior. The sensors also include a discharge temperature sensor 54 (discharge temperature detection device) for detecting a temperature of refrigerant Td discharged from the compressor 11, a discharge pressure sensor 55 (discharge pressure detection device) for detecting a pressure of refrigerant Pd discharged from the compressor 11, and an evaporator temperature sensor 56 (evaporator temperature detection device) for detecting a temperature of blown air TE (evaporator temperature) from the evaporator 15. The sensors further include a coolant temperature Tw sensor 58 for detecting a coolant temperature Tw of coolant flowing from the engine EG, a humidity sensor serving as a humidity detection device for detecting a relative humidity of air near the windshield in the vehicle interior, a nearby-windshield air temperature sensor for detecting the temperature of air near the windshield in the vehicle interior, and a windshield surface temperature sensor for detecting the temperature of the surface of the windshield.

The evaporator temperature sensor 56 of this embodiment detects, specifically, the temperature of a heat exchanging fin of the evaporator 15. As the evaporator temperature sensor 56, temperature detection means may be provided for detecting the temperature of any other part of the evaporator 15. Alternatively, another temperature detection means may be employed for directly detecting the temperature of a refrigerant itself flowing through the evaporator 15. Detection values from the humidity sensor, the nearby-windshield air temperature sensor, and the windshield surface temperature sensor are used to calculate the relative humidity RHW of the surface of the windshield.

Operation signals are input from various air conditioning operation switches provided in the operation panel 60 located near the instrumental panel at the front of the vehicle interior, to the input side of the air conditioning controller 50. Specifically, various air conditioning operation switches provided in the operation panel 60 include an operation switch of the vehicle air conditioner 1, an automatic switch, a selector switch for the operation modes, another selector switch for the air outlet modes, an air volume setting switch of the blower 32, a vehicle interior temperature setting switch, an economy switch, and a display for displaying the current operating state of the vehicle air conditioner 1.

The automatic switch serves as an automatic control setting portion for setting or resetting automatic control of the vehicle air conditioner 1 by the operation of the passenger. The vehicle interior temperature setting switch serves as a target temperature setting portion for setting a target temperature Tset of the vehicle interior by the operation of the passenger. The economy switch serves as energy saving requirement means for outputting an energy saving request signal that requests the energy saving of power required for air conditioning of the vehicle interior by the operation of the passenger.

By turning on the economy switch, a signal for decreasing the frequency of operation of the engine EG for assisting the electric motor for traveling is output to the driving force controller 70 in the EV operation mode.

The air conditioning controller 50 and the driving force controller 70 are electrically connected together and can be communicated with each other. Thus, based on a detection signal or operation signal input to one controller, the operation of each component whose output side is connected to the other controller can also be controlled. For example, when the air conditioning controller 50 outputs a request signal of the engine EG to the driving force controller 70, the engine EG can be operated, or the number of revolutions of the engine EG can be changed.

The air conditioning controller 50 and the driving force controller include integration of control means for controlling the components of interest for control to be connected to the output sides of the controllers. Structures (hardware and software) for controlling the operations of the components of interest for control serve as the control means for controlling the operation of the components of interest for control.

For example, a component of the air conditioning controller 50 serves as compressor control means that controls the refrigerant discharge capacity of the compressor 11 by controlling the frequency of AC voltage output from the invertor 61 connected to the electric motor 11b of the compressor 11. Another component of the air conditioning controller 50 serves as blower control means that controls the blowing capacity of the blower 32 by controlling the operation of the blower 32 as the blowing means. A further component (hardware and software) of the air conditioning controller serves as a request signal output device 50a that transmits and receives the control signal to and from the driving force controller 70.

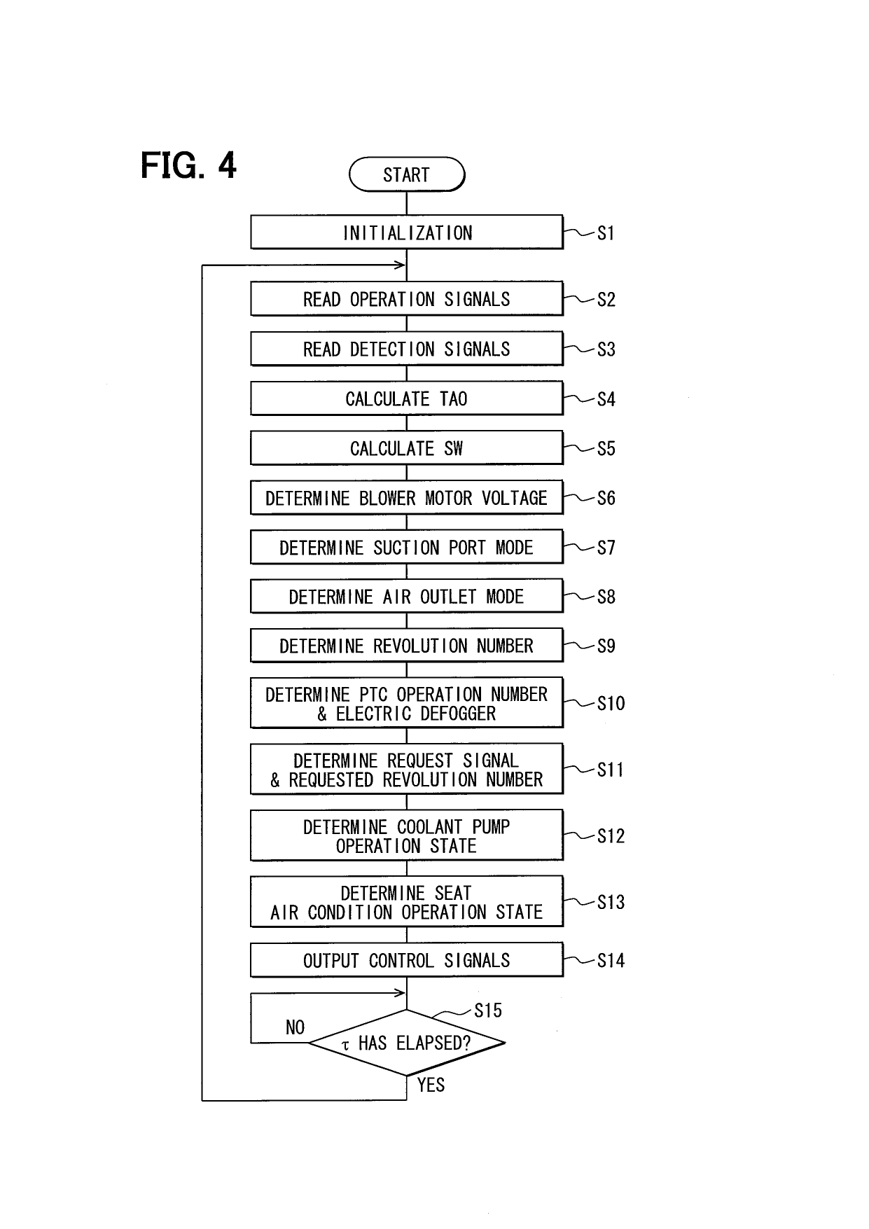

Now, the operation of the vehicle air conditioner 1 with the above structure in this embodiment will be described below with reference to FIGS. 4 to 9. FIG. 4 is a flowchart showing a control process as a main routine of the vehicle air conditioner 1 in this embodiment. The control process starts when the automatic switch is turned on with the operation switch of the vehicle air conditioner 1 being turned on. The respective control steps shown in FIGS. 4 to 8 form various function achievement means included in the air conditioning controller 50.

In step S1, first, initialization is performed which includes initialization of a flag, a timer, and the like, and initial alignment of a stepping motor included in the above electric actuator. In the initialization, some of flags or calculated values stored in the air conditioner 1 upon completion of the last operation of the vehicle air conditioner 1 are maintained.

Then, in step S2, the operation signals or the like of the operation panel 60 are read in, and the operation proceeds to step S3. Specifically, the operation signals include a target temperature Tset of the vehicle interior set by the vehicle interior temperature setting switch, a preset signal of a suction port mode switch, and an energy saving request signal output according to the operation of the economy switch.

Then, in step S3, signals regarding environmental conditions of the vehicle used for the control of air conditioning are read in. Specifically, the signals include detection signals from the above group of sensors 51 to 58 and the like. In step S3, parts of the detection signals from the sensor group connected to the input side of the driving force controller 70 and the control signals output from the driving force controller 70 are also read in from the driving force controller 70.

Then, in step S4, a target outlet air temperature TAO of air blown into the vehicle interior is calculated. The target outlet air temperature TAO is calculated by the following formula F1:

TAO=Kset×Tset−Kr×Tr−Kam×Tam−Ks×Ts+C (F1)

in which Tset is a preset temperature of the vehicle interior set by the vehicle interior temperature setting switch, Tr is an interior temperature (inside air temperature) detected by the inside air sensor 51, Tam is an outside air temperature detected by the outside air temperature 52, Ts is an amount of solar radiation detected by the solar radiation sensor 53, Kset, Kr, Kam, and Ks are control gains, and C is a constant for correction.

In subsequent steps S5 to S13, the control conditions of the respective components connected to the air conditioning controller 60 are determined. In step S5, first, a target opening degree SW of the air mix door 39 is calculated based on the target outlet air temperature TAO, a blown air temperature TE detected by the evaporator temperature sensor 56, and a warm air temperature TWD before the air mixing.

Specifically, the target opening degree SW can be calculated by the following formula F2:

SW=[{TAO−(TE+2)}/{TWD−(TE+2)}]×100(%) (F2)

The warm air temperature TWD before the air mixing is a value determined according to the heating capacities of the heater core 36 and PTC heater 37 disposed in the cool air passage 33 for heating. Specifically, the warm air temperature TWD can be calculated by the following formula F3:

TWD=Tw×0.8+TE×0.2+ΔTptc (F3)

in which Tw is a coolant temperature Tw detected by the coolant temperature Tw sensor 58, and ΔTptc is an increase in temperature of blown air by the operation of the PTC heater 37, that is, an increase in temperature to which the operation of the PTC heater 37 contributes, of the temperature (blown air temperature) of conditioned air blown from the air outlet into the vehicle interior. In this embodiment, specifically ΔTptc is set to 10° C. in operation of the PTC heater 37, or to 0° C. in non-operation thereof.

That is, the formula F3 determines the warm air temperature TWD before the air mixing, as a total of the increase in blown air temperature (Tw×0.8+TE×0.2) caused by the operation of the heater core 36 and the increase in blown air temperature ΔTptc caused by the operation of the PTC heater 37.

In the increase in blown air temperature (Tw×0.8+TE×0.2) caused by the operation of the heater core 36, when a heat exchange efficiency of the heater core 36 is 100%, the temperature of the air is increased to the coolant temperature Tw by the heater core 36. Actually, the heater core 36 has a heat exchange efficiency of about 80%, so that a coefficient is determined to be 0.8.

The inventors have found out through their studies that the increase in blown air temperature by the heater core 36 can be changed according to the temperature of the air flowing into the heater core 36. The temperature of the air to flow into the heater core 36 is the temperature of cool air cooled by the evaporator 15, and can be expressed by the blown air temperature TE, so that a coefficient of 0.2 experimentally determined is used as a contribution to the increase in blown air temperature of the air to flow into the heater core 36.

The increase in blown air temperature ΔTptc caused by the operation of the PTC heater 37 can be calculated by the following formula F4, using a power consumption W (Kw) of the PTC heater 37, an air density ρ (kg/m³), a specific air heat Cp, and a PTC passing air volume Va (m³/h) which is a volume of air passing through the PTC heater 37.

ΔTptc=W/ρ/Cp/Va×3600 (F4)

in which the PTC passing air volume Va is determined based on the volume of air from the blower 32 taking into consideration the air mix opening degree SW calculated in the previous step S5.

For SW=0%, the air mix door 39 is placed in the maximum cooling position to fully open the cool air bypass passage 34 and to completely close the cool air passage 33 for heating. In contrast, for SW=100%, the air mix door 39 is placed in the maximum heating position to completely close the cool air bypass passage 34 and to fully open the cool air passage 33 for heating.

In next step S6, a blowing capacity (blowing air volume) of the blower 32 is determined. Specifically, the blowing capacity of the blower 32 (specifically, a blower motor voltage to be applied to the electric motor) is determined with reference to a control map pre-stored in the air conditioning controller 50 based on the target outlet air temperature TAO determined in step S4.

More specifically, in this embodiment, the blower motor voltage is set to a high voltage near the maximum in an ultralow temperature range (maximum cooling range) of the TAO and in an ultrahigh temperature range (maximum heating range) of the TAO, so that the volume of air from the blower 32 is controlled to around the maximum volume of air. When the TAO is increased from the ultralow temperature range to an intermediate temperature range, the blower motor voltage decreases with increasing TAO, thereby decreasing the volume of air from the blower 32.

When the TAO is decreased from the ultrahigh temperature range to the intermediate temperature range, the blower motor voltage is decreased with decreasing TAO, thereby decreasing the volume of air from the blower 32. When the TAO enters a predetermined intermediate temperature range, the blower motor voltage is minimized to make the volume of air from blower 32 minimum.

In next step S7, a suction port mode, that is, a switching state of the inside/outside air switching box is determined. Specifically, the suction port mode is determined based on the TAO with reference to the control map pre-stored in the air conditioning controller 50. In this embodiment, the outside air mode for basically introducing the outside air is given higher priority, but when the TAO intends to be in the ultralow temperature range to obtain a high cooling performance, the inside air mode for introducing the inside air is selected. Further, an exhaust gas concentration detection device is provided for detecting an exhaust gas concentration of the outside air. When the exhaust gas concentration is equal to or higher than a predetermined reference concentration, the inside air mode may be selected.

In next step S8, the air outlet mode is determined. The air outlet mode is also determined based on the TAO with reference to the control map pre-stored in the air conditioning controller 50. In this embodiment, when the TAO is increased from a low temperature range to a high temperature range, the air outlet mode is switched from the foot mode to the bi-level mode and the face mode in that order.

Thus, in summer, the face mode is mainly selected, in spring and autumn, the bi-level mode is mainly selected, and in winter, the foot mode is mainly selected. When the fogging of the windshield can be highly anticipated based on a detection value of the humidity sensor, the foot defroster mode or the defroster mode may be selected.

In next step S9, a refrigerant discharge capacity of the compressor 11 (specifically, the number of revolutions (rpm)) is determined. In step S9, the target blown air temperature TEO of the blown air temperature Te of the air from the indoor evaporator 15 is determined with reference to the control map pre-stored in the air conditioning controller 50 based on the TAO or the like determined in step S4.

A deviation En (TEO−Te) between the target blown air temperature TEO and the blown air temperature Te is calculated. And a rate of change in deviation Edot (En−(En−1)) is determined by subtracting the last calculated deviation En−1 from the present calculated deviation En. Using the deviation En and the rate of change in deviation Edot, a change in number of revolutions Δf_C with respect to the last number of revolutions of the compressor fCn−1 is determined with reference to the fuzzy theory based on a membership function and a rule pre-stored in the air conditioning controller 50.

The membership function and rule stored in the air conditioning controller 50 of this embodiment determines the Δf_C so as to prevent the fogging of the indoor evaporator 15 based on the above deviation En and the rate of change in deviation Edot. Further, the number of revolutions of the compressor is updated by adding the amount of change in number of revolutions Δf_C to the previous number of revolutions fn−1 of the compressor to thus obtain the present number of revolutions fn of the compressor. The updating of the number of revolutions fn of the compressor is executed in one-second control cycle.

In next step S10, the number of operating PTC heaters 37 and the operating state of the electric defogger are determined. The way to determine the number of operating PTC heaters 37 will be described first. In step S10, the number of operating PTC heaters 37 is determined based on the outside air temperature Tam, the air mix opening degree SW, and the coolant temperature Tw.

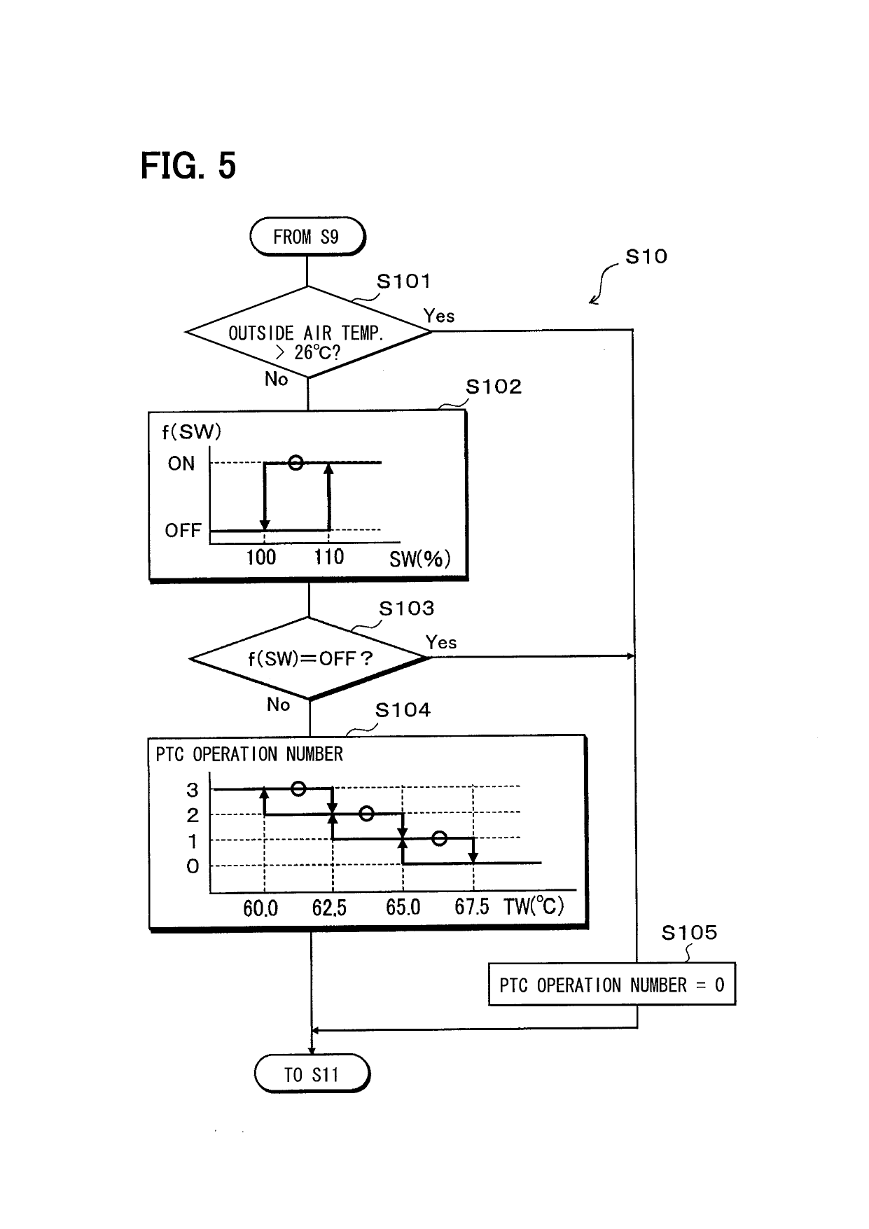

The details of the process in step S10 will be described below using the flowchart of FIG. 5. In step S101, first, it is determined whether the operation of the PTC heater 37 is necessary or not based on the outside air temperature. Specifically, it is determined whether or not the outside air temperature detected by the outside air sensor 52 is higher than a predetermined temperature (26° C. in this embodiment).

When the outside air temperature is determined to be higher than 26° C. in step S101, it is determined that the assistance of the PTC heater 37 in heating the blown air is not necessary. Then, the operation proceeds to step S105, in which the number of operating PTC heaters 37 is determined to be zero (0). In contrast, when the outside air temperature is determined to be equal to or less than 26° C. in step S101, the operation proceeds to step S102.

In steps S102 and S103, the necessity of the operation of the PTC heater 37 is determined based on the air mix opening degree SW. As the air mix opening degree SW becomes smaller, the necessity of heating the air through the cool air passage 33 for heating is diminished. Thus, the necessity of operating the PTC heater 37 is reduced with decreasing air mix opening degree SW.

In step S102, the air mix opening degree SW determined in step S5 is compared with a predetermined reference opening degree. When the air mix opening degree SW is equal to or less than a first reference opening degree (100% in this embodiment), the operation of the PTC heater 37 is determined not to be necessary, so that a PTC heater operation flag f(SW) is turned OFF, that is, f(SW)=OFF.

When the air mix opening degree is equal to or more than a second reference opening degree (110% in this embodiment), the operation of the PTC heater 37 is determined to be necessary, so that a PTC heater operation flag f(SW) is turned ON, that is, f(SW)=ON. A difference between the first reference opening degree and the second reference opening degree is set as a hysteresis width for preventing of control hunting.

Then, in step S103, when the PTC heater operation flag f(SW) determined in step S102 is turned OFF, the operation proceeds to step S105, in which the number of operating PTC heaters is determined to be zero (0). In contrast, when the PTC heater operation flag f(SW) is turned ON, the operation proceeds to step S104, in which the number of operating PTC heaters 37 is determined.

In step S104, the number of operating PTC heaters 37 is determined according to the coolant temperature Tw. Specifically, while the coolant temperature Tw is increasing, for the coolant temperature Tw≧a first predetermined temperature T1, the number of operating PTC heaters 37 is set to zero (0). For the first predetermined temperature T1>the coolant temperature Tw≧a second predetermined temperature T2, the number of operating PTC heaters is set to one (1). For the second predetermined temperature T2>the coolant temperature Tw≧a third predetermined temperature T3, the number of operating PTC heaters is set to two (2). For the third predetermined temperature T3>the coolant temperature Tw≧a fourth predetermined temperature T4, the number of operating PTC heaters is set to three (3).

In contrast, while the coolant temperature Tw is decreasing, for the fourth predetermined temperature T4≦the coolant temperature Tw, the number of operating PTC heaters 37 is set to three (3). For the fourth predetermined temperature T4<the coolant temperature Tw≦the third predetermined temperature T3, the number of operating PTC heaters 37 is set to two (2). For the three predetermined temperature T3<the coolant temperature Tw≦the second predetermined temperature T2, the number of operating PTC heaters 37 is set to one (1). For the second predetermined temperature T1<the coolant temperature Tw, the number of operating PTC heaters 37 is set to zero (0). Thereafter, the operation proceeds to step S11.

The respective predetermined temperatures T1, T2, T3, and T4 have the following relationship: T1>T2>T3>T4. In this embodiment, specifically, T1=67.5° C., T2=65° C., T3=62.5° C., and T4=60° C. A difference between the respective predetermined temperatures is set as the hysteresis width for preventing the control hunting.

In particular, as to the electric defogger, when the fogging is highly possibly caused on the windshield due to the humidity and temperature of the vehicle interior, or when the windshield is fogged, the electric defogger is operated.

In next step S11, a request signal to be output from the air conditioning controller 50 to the driving force controller 70 is determined. The request signals include an operation request signal of the engine EG (engine ON request signal), an operation stopping signal of the engine EG (engine OFF request signal), and a revolution-number request signal about the number of revolutions of the engine EG in operation of the engine EG or when the operation is requested.

In a normal vehicle whose driving force for traveling is obtained from only the engine EG, the engine constantly operates during traveling, so that the coolant is always at a high temperature. Thus, the normal vehicle allows the coolant to flow through the heater core 14 to exhibit the sufficient heating performance.

In contrast, in the plug-in hybrid vehicle of this embodiment, when traveling in the EV operation mode, the driving force for traveling can be obtained only from the electric motor for traveling. Thus, even when the high heating performance is required, the coolant temperature Tw is not sometimes increased to the sufficient level for a heat source for heating.

For this reason, in this embodiment, when the coolant temperature Tw is lower than the predetermined reference coolant temperature Tw regardless of the necessity of the high heating performance, an operation request signal and a revolution-number changing request signal are transmitted from the air conditioning controller 50 to the driving force controller 70 such that the engine EG is operated at an appropriate number of revolutions so as to keep the coolant temperature Tw at a predetermined temperature or more. In this way, the coolant temperature Tw is increased to thereby obtain the high heating performance.

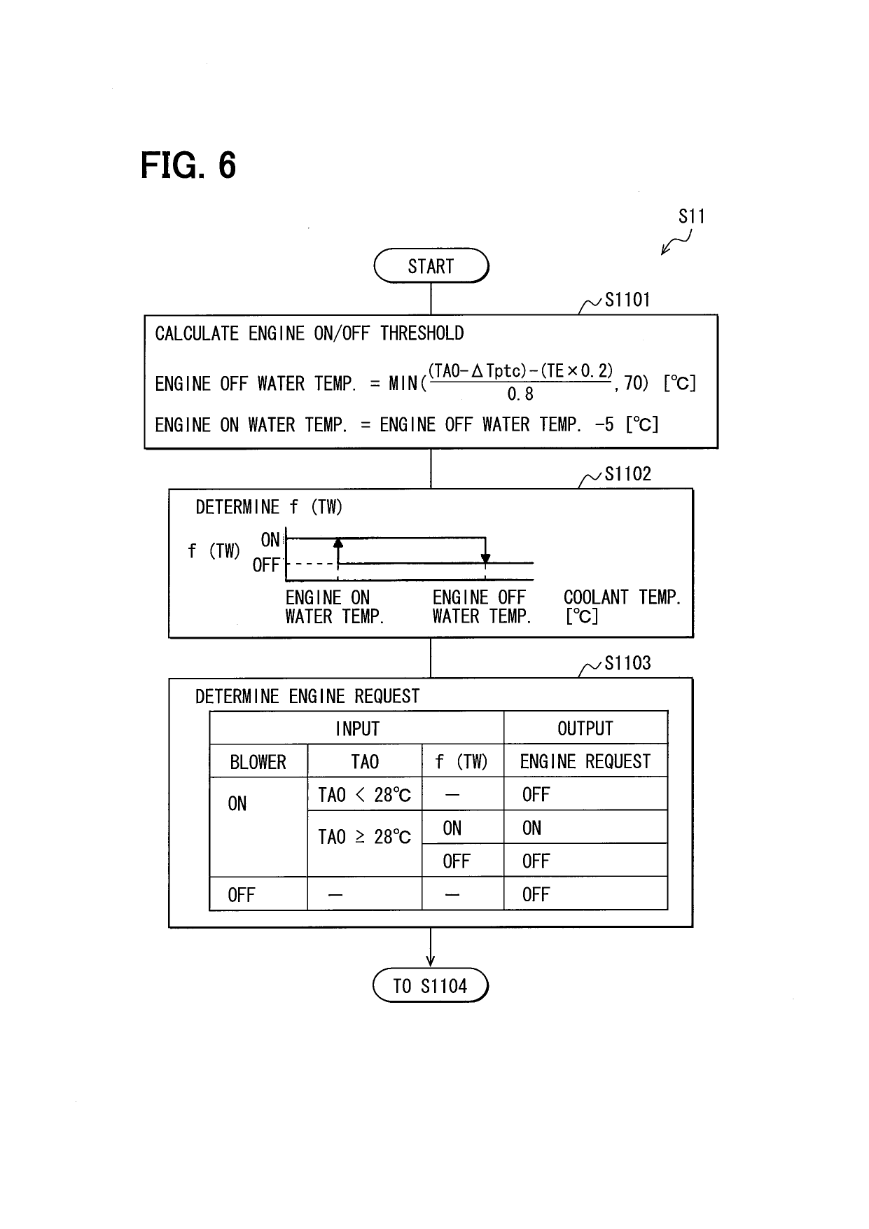

The details of the process in step S11 will be described below using the flowcharts of FIGS. 6 to 8. First, in step S1101, an engine ON water temperature and an engine OFF water temperature each are calculated as a determination threshold used for determining whether or not either the operation request signal or the operation stopping signal of the engine is output based on the coolant temperature Tw. The engine ON water temperature is the coolant temperature Tw serving as a determination reference for determining the output of the operation request signal, and the engine OFF water temperature is another coolant temperature Tw serving as another determination reference for determining the output of the operation stopping signal of the engine.

The engine OFF water temperature is a smaller one of 70° C. and the coolant temperature Tw required for the actual blown air temperature of the vehicle interior to reach the target outlet air temperature TAO. The coolant temperature Tw for the actual blown air temperature of the vehicle interior to reach the target outlet air temperature TAO can be calculated by the following formula F5.

{(TAO−ΔTptc)−(TE×0.2)}/0.8 (F5)

The above formula F5 corresponds to a formula modified so as to determine Tw in such a manner that the total of the increase in blown air temperature (Tw×0.8+TE×0.2) by the heater core 14 as described in the above step S5 and the increase in blown air temperature ΔTptc by the PTC heater 37 is equal to the TAO.

The engine ON water temperature is set slightly lower than the engine OFF water temperature by a predetermined value (5° C. in this embodiment) so as to prevent the frequent switching of the engine between ON and OFF. The predetermined value is set as the hysteresis width for preventing the control hunting. The engine OFF water temperature and the engine ON water temperature may be set to predetermined respective fixed values (for example, KTw=45° C., and KTw2=40° C.).

Then, in step S1102, a temporary request signal flag f(Tw) is determined according to the coolant temperature Tw. The signal flag f(Tw) indicates whether or not either the operation request signal or the operation stopping signal of the engine EG is output. Specifically, when the coolant temperature Tw is lower than the engine ON water temperature determined in step S1101, the temporary request signal flag f(Tw) is set to ON (f(Tw)=ON), and the outputting of the operation request signal of the engine EG is temporarily determined. When the coolant temperature Tw is higher than the engine OFF water temperature, the temporary request signal f(Tw) is set to OFF (f(Tw)=OFF), and then the outputting of the operation stopping signal of the engine EG is temporarily determined.

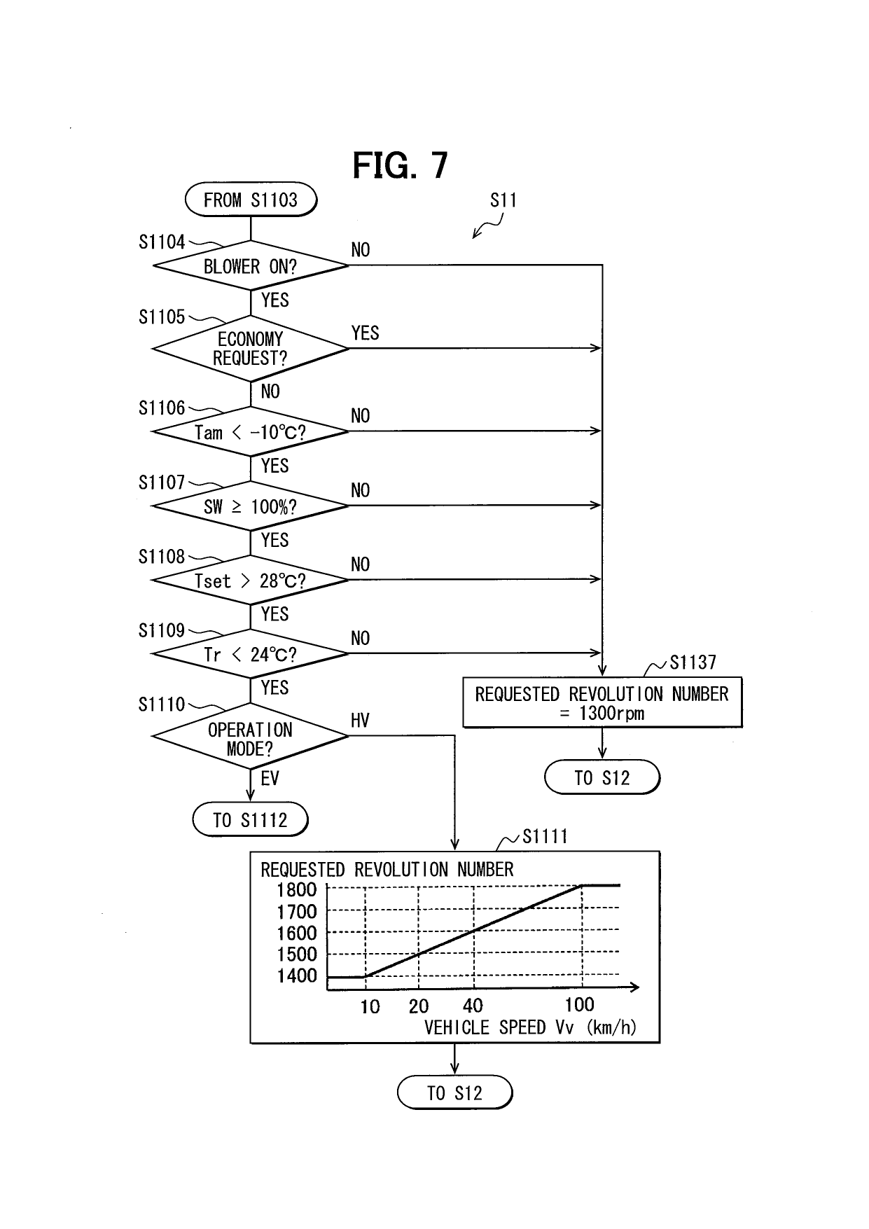

Then, in step S1103, a request signal to be output to the driving force controller 70 is determined based on the control map pre-stored in the air conditioning controller 50 with reference to the operating state of the blower 32, the outside air temperature Tam, and the temporary request signal flag f(Tw). Thereafter, the operation proceeds to step S1104 shown in FIG. 7.

Specifically, in step S1103, when the blower 32 is operating, and the target outlet air temperature TAO is less than 28° C., a request signal for stopping the engine EG is determined to be output regardless of the temporary request signal flag f(Tw).

When the blower 32 is operating, and the target outlet air temperature TAO is equal to or more than 28° C., with the temporary request signal flag f(Tw) being turned ON, a request signal for operating the engine EG is determined to be output, while with the temporary request signal flag f(Tw) turned OFF, a request signal for stopping the engine EG is determined to be output. When the blower 32 is not operating, a request signal for stopping the engine EG is determined regardless of the target outlet air temperature TAO and the temporary request signal flag f(Tw).

In the control process performed in the following steps S1104 to S1111 and S1117 shown in FIG. 7, a revolution-number request signal for the number of revolutions of the engine EG is determined. First, in step S1104, it is determined whether the blower 32 is operating or not. When the blower 32 is determined to be operating in step S1104, the operation proceeds to step S1105. In contrast, when the blower 32 is determined not to be operating in step S1104, the operation proceeds to step S1117, in which the requested number of revolutions of the engine EG is determined to be 1300 rpm. Then, the operation proceeds to step S12.

In step S1105, it is determined whether or not the economy switch is turned on. When the economy switch is determined not to be turned on in step S1105, the operation proceeds to step S1106. In contrast, when the economy switch is determined to be turned on in step S1105, the operation proceeds to step S1117, in which the requested number of revolutions of the engine EG is determined to be 1300 rpm. Then, the operation proceeds to step S12.

In step S1106, it is determined whether or not the outside air temperature Tam is lower than a predetermined reference outside air temperature (−10° C. in this embodiment). When the outside air temperature Tam is determined to be lower than the reference outside air temperature in step S1106, the operation proceeds to step S1107. In contrast, when the outside air temperature Ta is determined not to be lower than the reference outside air temperature in step S1106, the operation proceeds to step S1117, in which the requested number of revolutions of the engine EG is determined to be 1300 rpm. Thereafter, the operation proceeds to step S12.

In step S1107, it is determined whether the air mix opening degree SW determined in step S5 is equal to or more than 100%, that is, whether or not the air mix door 39 is located in the maximum heating position. When the air mix door 39 is determined to be located in the maximum heating position in step S1107, the operation proceeds to step S1108. In contrast, when the air mix door 39 is determined not to be located in the maximum heating position in step S1107, the operation proceeds to step S1117, in which the requested number of revolutions of the engine EG is determined to be 1300 rpm. Thereafter, the operation proceeds to step S12.

In step S1108, it is determined whether the target temperature Tset set by the interior temperature setting switch on the operation panel 60 is higher than the predetermined reference target temperature (28° C. in this embodiment). When the target temperature Tset is determined to be higher than the reference target temperature in step S1108, the operation proceeds to step S1109. In contrast, when the target temperature Tset is determined not to be higher than the reference target temperature in step S1108, the operation proceeds to step S1117, in which the requested number of revolutions of the engine EG is determined to be 1300 rpm. Thereafter, the operation proceeds to step S12.

In step S1109, it is determined whether the vehicle interior temperature Tr detected by the inside air sensor 51 is lower or not than a predetermined reference vehicle interior temperature (24° C. in this embodiment). When the vehicle interior temperature Tr is determined to be lower than the reference vehicle interior temperature in step S1109, the operation proceeds to step S1110. In contrast, when the vehicle interior temperature Tr is determined not to be lower than the reference vehicle interior temperature in step S1109, the operation proceeds to step S1117, in which the requested number of revolutions of the engine EG is determined to be 1300 rpm. Thereafter, the operation proceeds to step S12.

In the subsequent step S1110, it is determined whether the operation mode of the vehicle is the EV operation mode or in the HV operation mode. As mentioned above, the hybrid vehicle of this embodiment is operated in the following way. When the remaining storage level SOC of the battery 81 is equal to or more than the predetermined reference remaining level for traveling, the remaining storage level SOC of the battery 81 is determined to be sufficient, thereby bringing the vehicle into the EV operation mode. When the remaining storage level SOC of the battery is less than the predetermined reference remaining level for traveling, the remaining storage level SOC of the battery 81 is determined to be insufficient, which brings the vehicle into the HV operation mode.

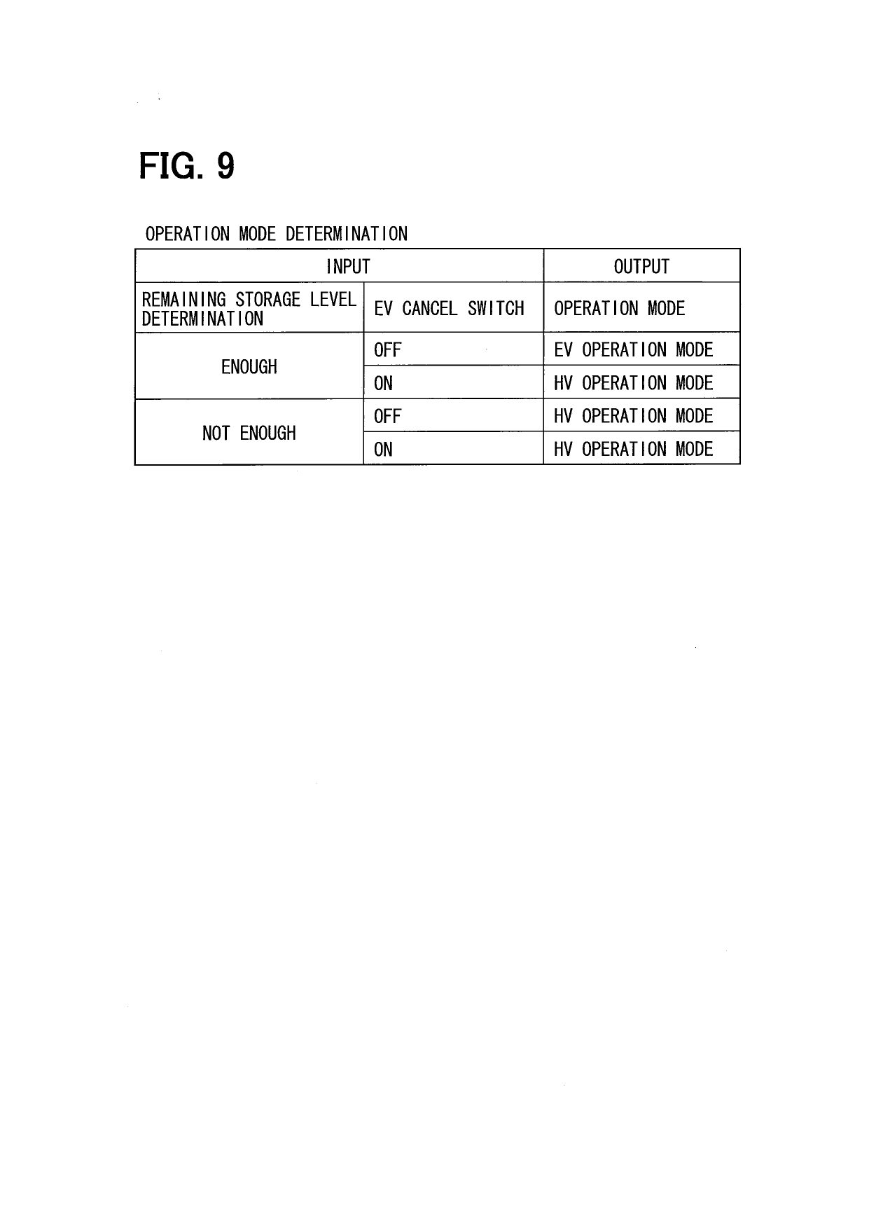

More specifically, as shown in the table of FIG. 9, the operation mode is determined. When an EV cancel switch for requesting the driving force controller 70 not to execute the EV operation mode is turned on (ON) by the operation of the passenger, the HV operation mode is selected even if the remaining storage level SOC of the battery 81 is enough.

When the vehicle is determined to be in the HV operation mode in step S1110, the operation proceeds to step S1111. In this step, the requested number of revolutions of the engine EG is determined based on the vehicle speed Vv detected by the vehicle speed sensor with reference to the control map pre-stored in the air conditioning controller 50. Then, the operation proceeds to step S12. Specifically, in this embodiment, the requested number of revolutions of the engine EG is determined to decrease with decreasing vehicle speed Vv.

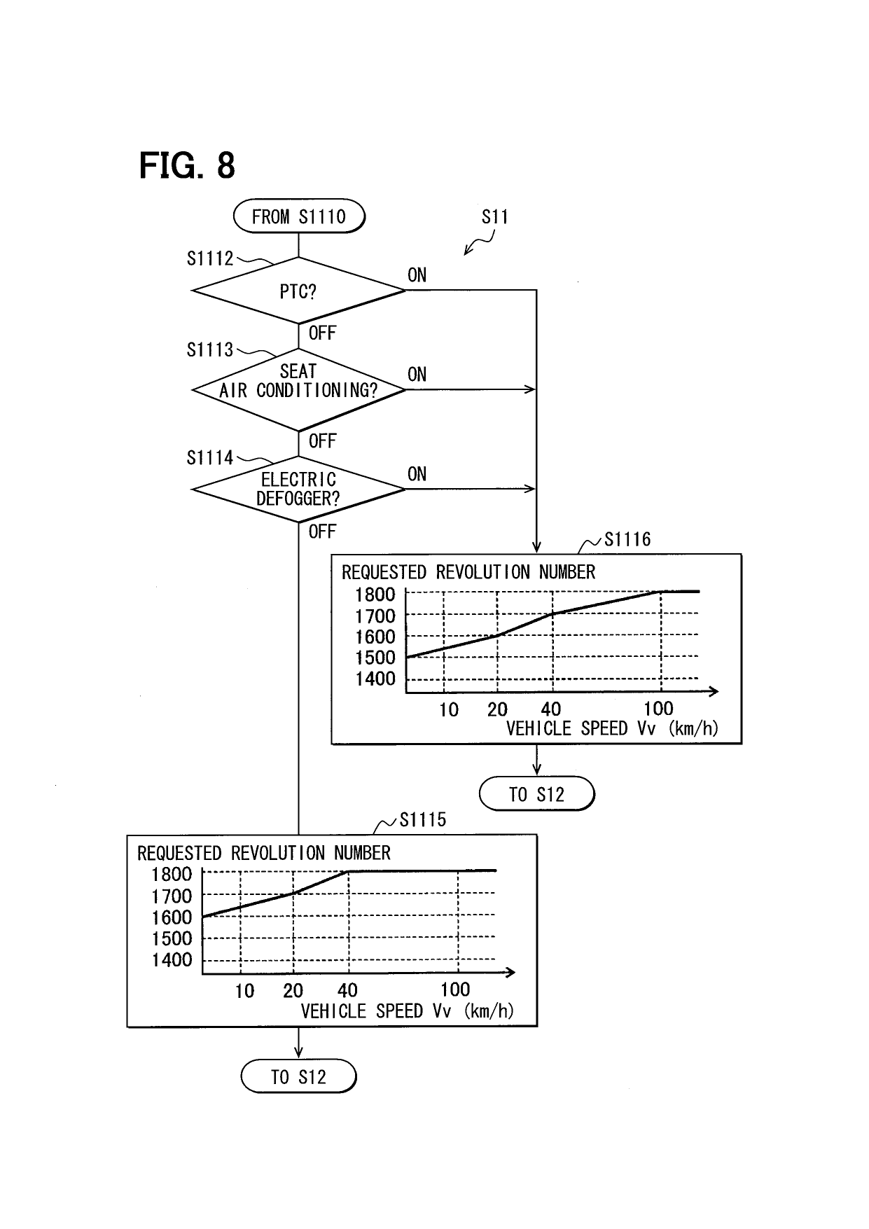

In contrast, when the vehicle is determined to be in the EV operation mode in step S1110, the operation proceeds to step S1112 shown in FIG. 8. In step S1112, it is determined whether the PTC heater 37 is operating or not. When the PTC heater 37 is determined to be operated in step S1112, the operation proceeds to step S1116. In contrast, when the PTC heater 37 is determined not to be operating in step S1112, the operation proceeds to step S1113.

In step S1113, it is determined whether the seat air conditioner is operating or not. When the seat air conditioner 90 is determined to be operating in step S1113, the operation proceeds to step S1116. In contrast, when the seat air conditioner 90 is determined not to be operating in step S1113, the operation proceeds to step S1114.

In step S1114, it is determined whether the electric defogger is operating or not. When the electric defogger is determined to be operating (energized) in step S1114, the operation proceeds to step S1116. In contrast, when the electric defogger is determined not to be operating in step S1114, the operation proceeds to step S1115.

Like in step S1111, in step S1115, the requested number of revolutions of the engine EG is determined based on the vehicle speed Vv with reference to the control map pre-stored in the air conditioning controller 50, and then the operation proceeds to step S12. Specifically, in this embodiment, the requested number of revolutions of the engine EG is determined to decrease with decreasing vehicle speed Vv. At this time, in a range of 0 to 100 km/hr of the vehicle speed Vv, the requested number of revolutions of the engine EG is determined to be higher than that determined in step S1111.

Like in step S1111, in step S1116, the requested number of revolutions of the engine EG is determined based on the vehicle speed Vv with reference to another control map pre-stored in the air conditioning controller 50, and then the operation proceeds to step S12. Specifically, in this embodiment, the requested number of revolutions of the engine EG is determined to decrease with decreasing vehicle speed Vv.

At this time in the range of 0 to 100 km/hr of the vehicle speed Vv, the requested number of revolutions of the engine EG is determined to be higher than that determined in step S1111, and lower than that determined in step S1115.

As mentioned above, in this embodiment, when the operation mode is determined to be the EV operation mode in step S1110, the requested number of revolutions of the engine EG is set higher than that determined in the HV operation mode.

That is, in the EV operation mode in which the motor-side driving force is more than the internal combustion engine-side driving force and the coolant temperature Tw is less likely to increase, a request signal is determined such that the requested number of revolutions of the engine EG is higher than that in the HV operation mode. In short, in the EV operation mode in which the driving force ratio (motor-side driving force/internal combustion engine-side driving force) is relatively high and the coolant temperature TW is less likely to increase, a request signal is determined such that the requested number of revolutions of the engine EG is increased as compared to in the HV operation mode.

In the EV operation mode, when at least one of the PTC heater 37, the seat air conditioner 90, and the electric defogger is operating, the requested number of revolutions of the engine EG becomes high as compared to when none of them are operating.

That is, when the PTC heater 37 or seat air conditioner 90 is operating as the auxiliary heater even in the EV operation mode, the request signal is determined such that the requested number of revolutions of the engine EG is higher than that when none of them are operating. Further, when the electric defogger is operating even in the EV operation mode, the request signal is also determined such that the requested number of revolutions of the engine EG is higher than that when the defogger is not operating.

In next step S12, it is determined whether or not the coolant pump 40a for circulating the coolant between the heater core 36 and the engine EG is operated by the coolant circuit 40. The details of the process in step S12 will be described below. First, in step S12, it is determined whether the coolant temperature Tw is higher than the blown air temperature TE.

When the coolant temperature Tw is determined to be equal to or lower than the blown air temperature TE in step S12, the coolant pump 40a is determined to be stopped (turned OFF). This is because when the coolant flows through the heater core 36 while the coolant temperature Tw is equal to or less than the blown air temperature TE, the coolant flowing through the heater core 36 might cool the air having passed through the evaporator 15, thus decreasing the temperature of air blown from the air outlet.

When the coolant temperature Tw is determined to be higher than the blown air temperature TE in step S12, it is determined whether the blower 32 is operating or not. When the blower 32 is determined not to be operating in step S12, the coolant pump 40a is determined to be stopped (turned OFF) so as to achieve energy saving.

In contrast, when the blower 32 is determined to be operating in step S12, the coolant pump 40a is determined to be operated (turned ON). As a result, the coolant pump 40a is operated to circulate the coolant through the refrigerant circuit, which exchanges heat between the coolant flowing through the heater core 36 and the air passing through the heater core 36 to thereby heat the air.

Then, in step S13, it is determined whether or not the operation of the seat air conditioner 90 is necessary. The operation state of the seat air conditioner 90 is determined based on the target outlet air temperature TAO determined in step S5, the operation state of the PTC heater 37 determined in step S10, the target temperature Tset of the vehicle interior read in step S2, and the outside air temperature Tam with reference to the control map pre-stored in the air conditioning controller 50.

When the target outlet air temperature TAO is lower than 100° C. and the PTC heater 37 is operating, that is, when one or more of the first to third PTC heaters 37a, 15b, and 15c is operating, the outside air temperature Tam is equal to or less than a predetermined reference outside air temperature, and the target temperature Tset is lower than a predetermined reference seat air conditioner operation temperature, the seat air conditioner 90 is determined to be operated (turned ON).

When the target outlet air temperature TAO is equal to or more than 100° C., the seat air conditioner 90 is determined to be operated (turned ON) regardless of the operation state of the PTC heater 37, the outside air temperature Tam, and the target temperature Tset. Even if the economy switch of the operation panel 60 is turned on when the conditions for operating (turning ON) the seat air conditioner 90 are satisfied, the seat air conditioner 90 may be non-operated (turned OFF).

In step S14, control signals and control voltages are output by the air conditioning controller 50 to various components 32, 12a, 61, 62, 63, 64, 12a, 37, 40a, and 80 so as to obtain the control states determined in the above steps S5 to S13. Further, the request signal for the operation of the engine EG and/or the request signal for the requested number of revolutions of the engine EG determined in step S11 are transmitted from the request signal output device 50c to the engine controller 70.

In next step S15, the air conditioner waits for the control cycle τ, and when the interval of the control cycle τ has elapsed, the operation returns to step S2. In this embodiment, the control cycle τ is 250 ms. This is because the controllability of the air conditioning of the vehicle interior is not adversely affected even by a slow control cycle as compared to the engine control or the like. This arrangement can sufficiently ensure the quantity of communication of a control system required to perform the high-speed control, such as engine control, while suppressing the quantity of communication for the air conditioning control of the vehicle interior.

The vehicle air conditioner 1 of this embodiment is operated as mentioned above, whereby the air blown from the blower 32 is cooled by the evaporator 15. The cool air cooled by the evaporator 15 flows into the cool air passage 33 for heating and the cool air bypass passage 34 according to the opening degree of the air mix door 39.

The cool air flowing into the cool air passage 33 for heating is heated while passing through the heater core 36 and the PTC heater 37, and then mixed with the cool air having passed through the cool air bypass passage 34 in the mixing space 35. Then, the conditioned air whose temperature is adjusted by the mixing space 35 is blown out into the vehicle interior from the mixing space 35 via the air outlets.

When the inside air temperature Tr of the vehicle interior is cooled lower than the outside air temperature Tam by the conditioned air blown into the vehicle interior, the cooling of the vehicle interior is achieved. In contrast, when the inside air temperature Tr is heated higher than the outside air temperature Tam, the heating of the vehicle interior is achieved.

The vehicle air conditioner 1 of this embodiment makes the requested number of revolutions output in the EV operation mode higher than the requested number of revolutions output in the HV operation mode as mentioned in the paragraph about the control step S11. Although in the EV operation mode, the motor-side driving force is more than the internal combustion engine-side driving force and the temperature of the coolant is less unlikely to increase, the vehicle air conditioner 1 of this embodiment with the above arrangement can increase the temperature of the coolant to a sufficient level required for the heat source for heating even in the EV operation mode.

Thus, the air to be blown into the vehicle interior in the EV operation mode can be sufficiently heated by the heater core 36, and thereby it can achieve the sufficient heating of the vehicle interior.

At this time, as mentioned in the paragraph about the step S1106, when the outside air temperature Tam is equal to or less than the reference outside air temperature regardless of the EV operation mode and the HV operation mode, the requested number of revolutions of the engine EG is increased as compared to when the outside air temperature Tam is higher than the reference outside air temperature.

Since the requested number of revolutions of the engine EG is increased with decreasing outside air temperature Tam, when a high heating capacity is requested, for example, at a low outside air temperature, the coolant temperature Tw can be increased up to the sufficient level for the heat source for heating. When the outside air temperature Tam is higher than the reference outside air temperature, the requested number of revolutions of the engine EG is decreased, and thereby it can also achieve energy saving of the engine EG.

As described in the paragraph of step S1108, when the target temperature Tset is higher than the reference target temperature, the requested number of revolutions of the energy EG is increased regardless of the EV operation mode and the HV operation mode, as compared to when the target temperature Tset is equal to or less than the reference target temperature.

That is, since the requested number of revolutions of the engine EG is increased with increasing target temperature Tset, when the high heating capacity is requested by the passenger, the coolant temperature Tw can be increased up to a sufficient level for the heat source for heating. When the target temperature Tset is equal to or less than the reference target temperature, the requested number of revolutions of the engine EG is decreased, and thereby it can also achieve the energy saving of the engine EG.

As described in the paragraphs of steps S1112 to S1116, when at least one of the PTC heater 37 and the seat air conditioner 90 as the auxiliary heater is operating even in the EV operation mode, the request signal is output to increase the requested number of revolutions of the engine EG as compared to when none of them are operating. Thus, when the high heating capacity is requested, for example, when the warm feeling of the passenger is assisted by the auxiliary heaters 37 and 90, the coolant temperature Tw can be increased up to the sufficient level for the heat source for heating.

When the electric defogger is operating as another auxiliary heater, the request signal is output so as to increase the requested number of revolutions of the engine EG as compared to when none of them are operating. Thus, when the high antifogging capacity is requested so as to prevent fogging of the windshield W of the vehicle, the coolant temperature Tw can be increased up to the sufficient level for the heat source for heating.

As described in the paragraph of step S1105, when the economy switch of the operation panel 60 is turned on, the request signal is output so as to decrease the requested number of revolutions, regardless of the EV operation mode and the HV operation mode, and regardless of the operation states of the auxiliary heaters 37 and 90 and the electric defogger, as compared to when the economy switch is not turned on.

That is, when the energy saving is requested by the passenger, the request signal is output so as to decrease the requested number of revolutions, and thereby it can achieve the energy saving according to the passenger's will (that is, according to the need for energy saving). Passengers who are very eager to save energy do not feel uncomfortable to a slight decrease in heating capacity.

As described in the paragraphs of steps S1111, 1115, and 1116, the request signal is output such that the requested number of revolutions is increased with increasing vehicle speed Vv. Thus, the requested number of revolutions can also be changed according to a load on traveling which increases with increasing vehicle speed Vv.

### Second Embodiment

In the first embodiment, in order to increase the coolant temperature Tw up to the sufficient level for the heat source for heating, the requested number of revolutions of the engine EG is increased to thereby decrease the driving force ratio (motor-side driving force/internal combustion engine-side driving force), by way of example. In this embodiment, however, the control form in step S11 of the first embodiment is changed to thereby decrease the motor-side driving force, which results in a decrease in driving force ratio, by way of example.

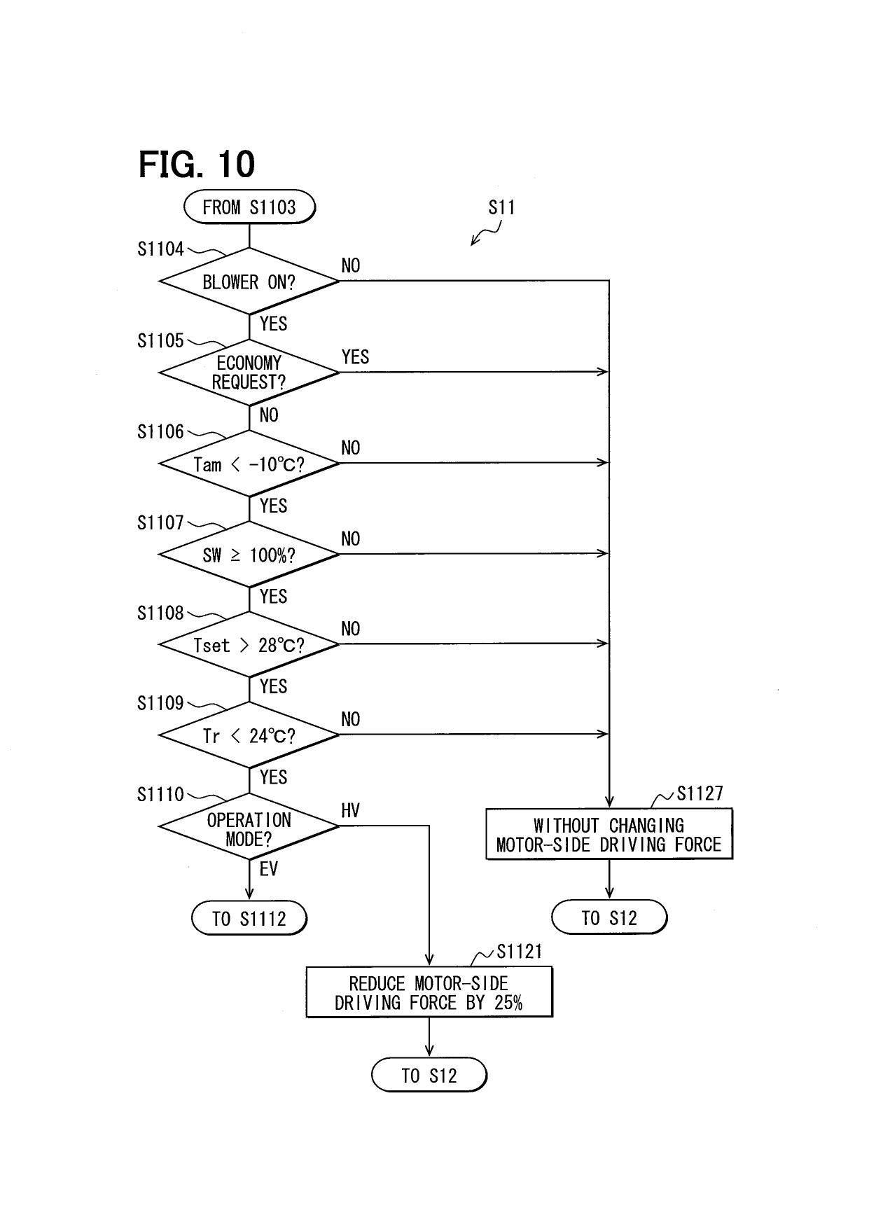

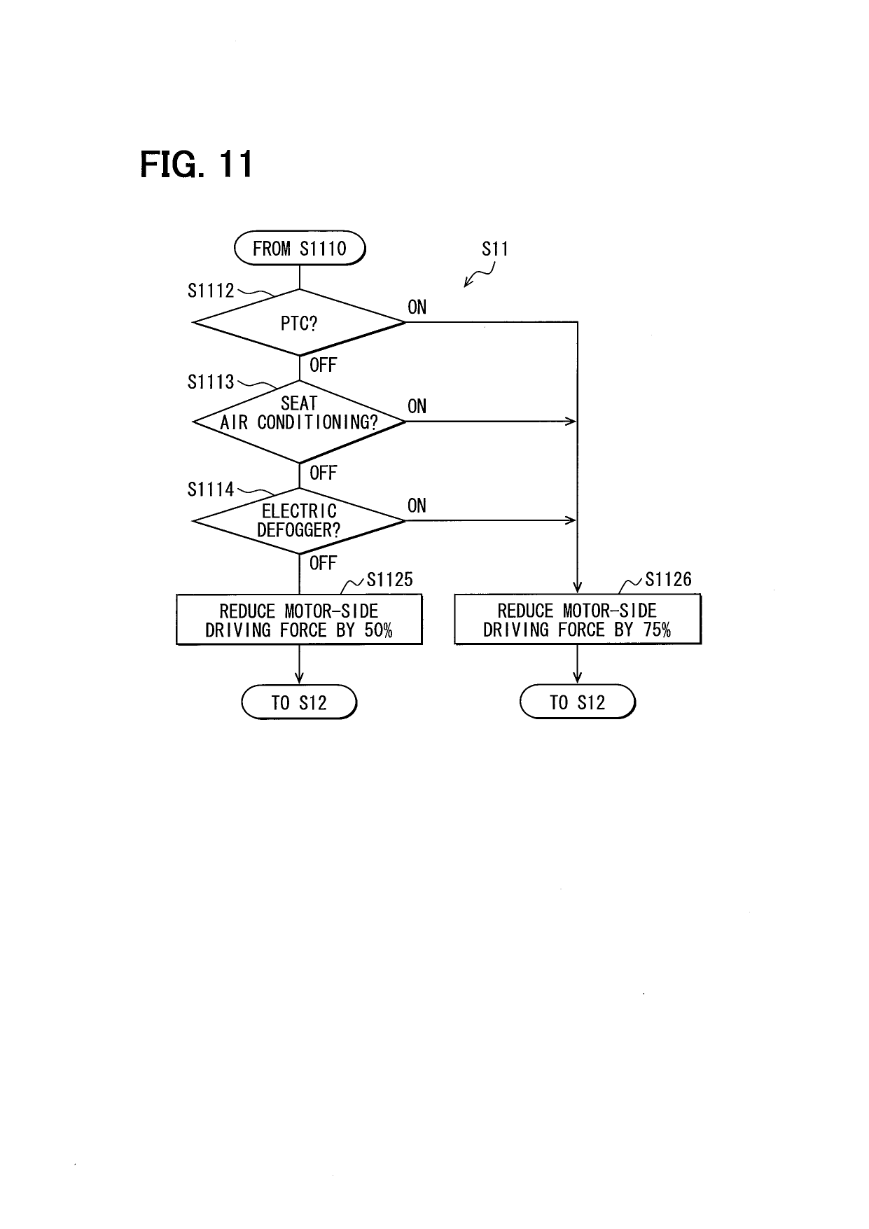

Specifically, as shown in FIGS. 10 and 11, the control flow following the process in step S1103 of FIG. 6 is changed. In any one of steps S1104 to S1110 of FIG. 10, first, like the first embodiment, it is determined whether or not the blower 32 is operating, whether or not the economy switch is turned on, whether or not the outside air temperature Tam is lower than the predetermined reference outside air temperature, whether or not the air mix door 39 is located in the maximum heating position, whether or not the target temperature Tset is higher than the predetermined reference target temperature, whether or not the vehicle interior temperature Tr is lower than the predetermined reference vehicle interior temperature, or whether the operation mode is the EV operation mode or HV operation mode.

For example, when the blower 32 is determined not to be operating in step S1104, the operation proceeds to step S1127, in which the motor-side driving force is determined not to be decreased. Then, the operation proceeds to step S12. The same goes for the processes in steps S1105 to S1109.

When the vehicle is determined to be in the HV operation mode in step S1110, the operation proceeds to step S1121, in which the motor-side driving force is reduced by 25%. Then, the operation proceeds to step S12. In contrast, when the vehicle is determined to be in the EV operation mode in step S1110, the operation proceeds to step S1112 shown in FIG. 11. In any one of steps S1112 to S1114, like the first embodiment, it is determined whether the PTC heater 37 is operating or not, whether the seat air conditioner is operating or not, or whether the electric defogger is operating or not.

For example, when the PTC heater 37 is determined to be operating in step S1112, the operation proceeds to step S1126, in which the motor-side driving force is decreased by 75%. Then, the operation proceeds to step S12. In contrast, when the PTC heater 37 is determined to be operating in step S1112, the operation proceeds to step S1125, in which the motor-side driving force is reduced by 50%. Then, the operation proceeds to step S12.

As mentioned above in this embodiment, when the operation mode is determined to be the EV operation mode in step S1110, the request signal is determined to increase a decrease in motor-side driving force as compared to in the HV operation mode. That is, the request signal is determined such that the driving force ratio (motor-side driving force/internal combustion engine-side driving force) is reduced by decreasing the motor-side driving force.

Further, when at least one of the PTC heater 37, the seat air conditioner 90, and the electric defogger is operating in the EV operation mode, the requested number of revolutions of the engine EG for reducing the motor-side driving force becomes high as compared to when none of them are operating.

That is, when even in the EV operation mode, the PTC heater 37 or the seat air conditioner 90 is operating as the auxiliary heater, the request signal is determined to increase the decrease in motor-side driving force as compared to when none of them are operating. When the electric defogger is operating even in the EV operation mode, the request signal is determined to increase the decrease in motor-side driving force as compared to when none of them are operating.

The operations and structures of other components of this embodiment are the same as those of the first embodiment. Thus, the vehicle air conditioner 1 of this embodiment can obtain the same effects as those of the first embodiment.

That is, in the vehicle air conditioner 1 of this embodiment, in the EV operation mode in which the motor-side driving force is more than the internal combustion engine-side driving force and the coolant temperature Tw is less likely to increase, the request signal is output so as to decrease the driving force ratio. In order not to change the driving force for traveling of the vehicle, the internal combustion engine-side driving force is increased.

Thus, in the EV operation mode, the coolant temperature Tw can be increased to the sufficient level for the heat source for heating to sufficiently heat the air blown into the vehicle interior by the heater core 36, and thereby it can achieve the sufficient heating of the vehicle interior.

At this time, as shown in steps S1106 and S1108 of FIG. 10, when the outside air temperature Tam is equal to or less than the reference outside air temperature, or when the target temperature Tset is higher than the reference target temperature, the request signal is output so as to decrease the driving ratio. Like the first embodiment, when the high heating capacity is requested, the coolant temperature Tw can be increased up to the sufficient level for the heat source for heating.

As shown in steps S1112 to S1116 of FIG. 11, even in the EV operation mode, when the PTC heater 37 or the seat sir conditioner 90 as the auxiliary heater is operating, the request signal is output so as to decrease the driving force ratio, as compared to when none of them are operating. Like the first embodiment, when the high heating capacity is requested, the coolant temperature Tw can be increased up to the sufficient level for the heat source for heating.

When the electric defogger as another auxiliary heater is operating, the request signal is also output so as to decrease the driving force ratio, as compared to when it is not operating. Thus, like the first embodiment, when the high antifogging capacity is requested to prevent the fogging of the windshield W of the vehicle, the coolant temperature Tw can be increased up to the sufficient level for the heat source for heating.

As shown in step S1105 of FIG. 10, when the economy switch on the operation panel 60 is turned on, the driving force ratio is not decreased, so that the energy saving according to the passenger's will (that is, according to the need for energy saving) can be achieved, like the first embodiment.

### Third Embodiment

This embodiment changes the control of the process in step S11 of the first embodiment. In this embodiment, even when the EV operation mode is selected as the operation mode described in the table of FIG. 9 of the first embodiment, switching of the operation mode into the HV operation mode whose driving force ratio is smaller will increase the coolant temperature Tw up to the sufficient level for the heat source for heating, by way of example.

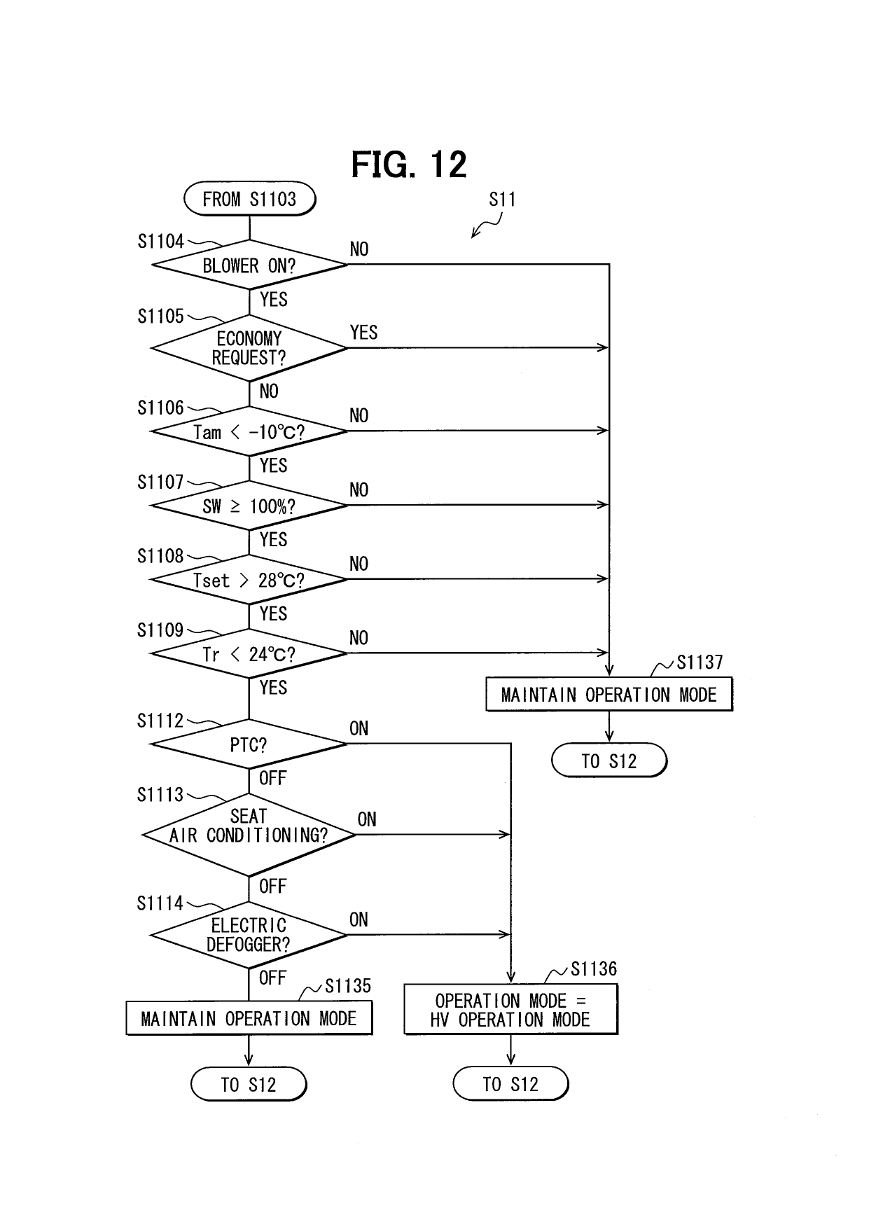

Specifically, as shown in FIG. 12, a control flow following step S1103 in FIG. 6 is changed. First, in any one of steps S1104 to S1109 of FIG. 12, it is determined whether the blower 32 is operating or not, whether or not the economy switch is turned on, whether or not the outside air temperature Tam is lower than the predetermined reference outside air temperature, whether or not the air mix door 39 is located in the maximum heating position, whether or not the target temperature Tset is higher than the predetermined reference target temperature, or whether or not the vehicle interior temperature Tr is lower than the predetermined reference vehicle interior temperature.

For example, when the blower 32 is determined not to be operating in step S1104, the operation proceeds to step S1137, in which the operation mode determined by the table of FIG. 9 is maintained, and then the operation proceeds to step S12. The same goes for the following steps S1105 to S1109. In steps S1112 and S1113, like the first embodiment, it is determined whether the PTC heater 37 is operating or not, and whether the seat air conditioner is operating or not.

For example, when the PTC heater 37 is determined to be operating in step S1112, the operation proceeds to step S1136, in which the operation mode is determined to be the HV operation mode regardless of the operation mode determined in the table of FIG. 9. Then, the operation proceeds to step S12. In contrast, when the PTC heater 37 is determined not to be operating in step S1112, the operation proceeds to step S1135, in which the operation mode determined in the table of FIG. 9 is maintained.

The operations and structures of other components of this embodiment are the same as those of the first embodiment. Thus, in the air conditioner 1 of this embodiment, when at least one of the PTC heater 37 and the seat air conditioner 90 is operating and the high heating capacity is required, the operation mode is switched into the HV operation mode in which the internal combustion engine-side driving force is more than that of the motor-side driving force, so that the coolant temperature Tw can be increased to the sufficient level for the heat source for heating.

In this embodiment, the operation mode is switched into the HV operation mode when the following conditions are satisfied. That is, the blower 32 is operating, the economy switch is not turned on, the outside air temperature Tam is lower than the predetermined reference outside air temperature, the air mix door 39 is located in the maximum heating position, the target temperature Tset is higher than the predetermined reference target temperature, and the vehicle interior temperature Tr is lower than the predetermined reference vehicle interior temperature. In this case, when at least one of the PTC heater 37 and the seat air conditioner 90 is operating, the operation mode is switched into the HV operation mode. The conditions for switching into the HV operation mode, however, are not limited thereto.

Alternatively, when the outside air temperature Tam is higher than the reference outside air temperature, the operation mode may be switched into the HV operation mode. When the target temperature Tset is equal to or more than the predetermined reference target temperature, the operation mode may be switched into the HV operation mode. When the economy switch is not turned on, the operation mode may be switched into the HV operation mode.

### Fourth Embodiment

This embodiment is a modified example of the third embodiment, by way of example. Even when the EV operation mode is selected as the operation mode, the coolant temperature Tw can be increased to the sufficient level for the heat source for heating by switching the operation mode into the HV operation mode whose driving force ratio is low.

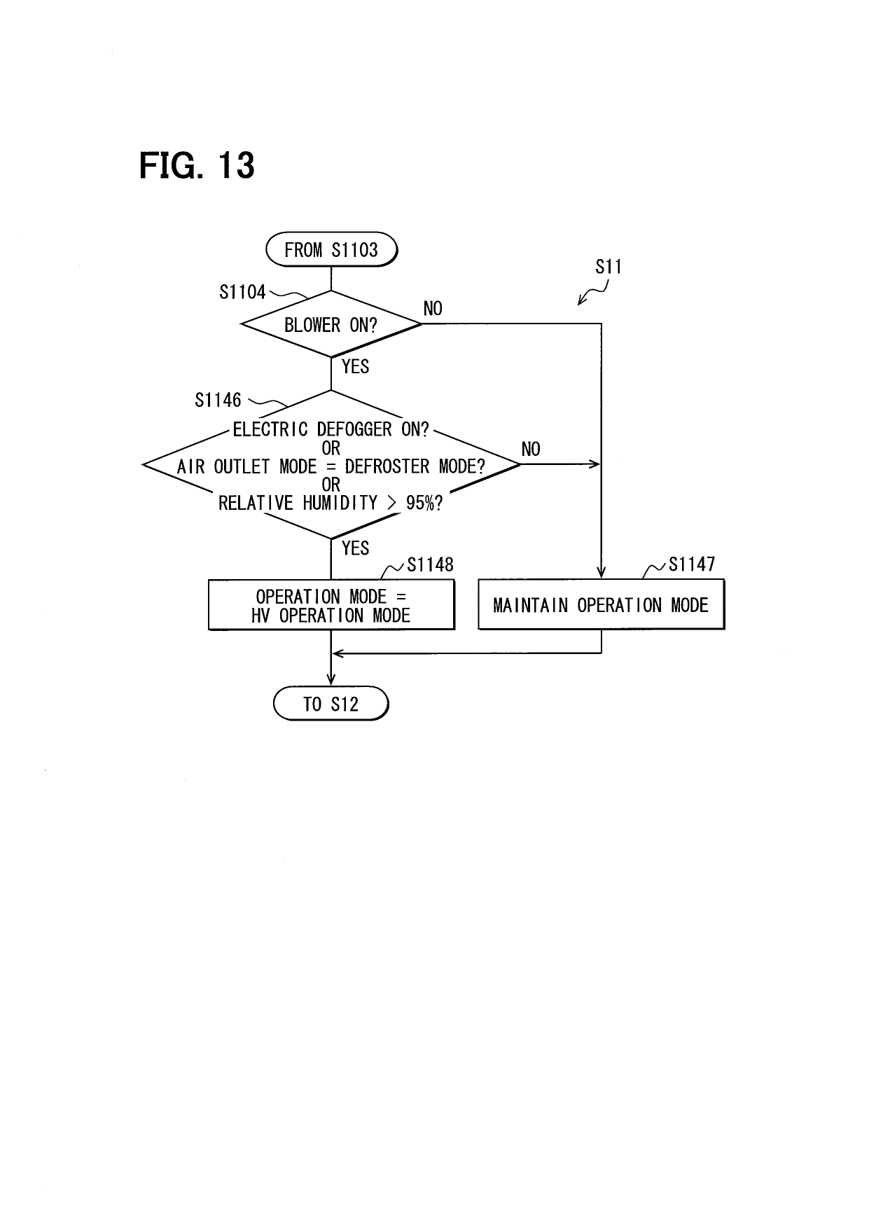

Specifically, as shown in FIG. 13, a control flow following the step S1103 shown in FIG. 6 is changed. In step S1104 of FIG. 13, first, like the first embodiment, it is determined whether the blower 32 is operating or not. When the blower 32 is determined not to be operating in step S1104, the operation proceeds to step S1147, in which the operation mode determined by the table of FIG. 9 is maintained. Then, the operation proceeds to step S12.

When the blower 32 is determined to be operating in step S1104, the operation proceeds to step S1146, in which it is determined whether or not at least one of the following conditions is satisfied. Specifically, it is determined whether the electric defogger is operating or not, whether the air outlet mode is a defroster mode or not, or whether or not the relative humidity near the windshield W of the vehicle is higher than 95%.

Furthermore, when at least one of the above conditions is determined to be satisfied in step S1146, the operation proceeds to step S1148, in which the operation mode is determined to be the HV operation mode regardless of the operation mode determined by the table of FIG. 9, and then the operation proceeds to step S12. When any of the above conditions is determined not to be satisfied in step S1146, the operation proceeds to step S1147.

The operations and structures of other components of this embodiment are the same as those of the first embodiment. In the vehicle air conditioner 1 of this embodiment, when the blower 32 is determined to be operating, the operation proceeds to step S1146. When at least one of the following conditions is determined to be satisfied in step S1146, the operation mode is switched into the HV operation mode in which the internal combustion engine-side driving force is more than the motor-side driving force. Specifically, the conditions include whether the electric defogger is operating or not, whether the air outlet mode is the defroster mode or not, and whether the relative humidity near the vehicle windshield W is higher than 95%. As a result, the coolant temperature Tw can be increased to the sufficient level for the heat source for heating.

### Other Embodiments

The present invention is not limited to the above embodiments, and various modifications and changes can be made to those disclosed embodiments without departing from the scope of the invention.

(1) In the above embodiments, when the outside air temperature is an ultralow temperature lower than −10° C., the vehicle air conditioner 1 is required to have a high heating capacity, and thus the auxiliary heaters 37 and 90 are operated. Further, in the first embodiment, in the EV operation mode, the increase in number of revolutions of the engine EG is increased as compared to in the HV operation mode to thereby increase the coolant temperature Tw. Depending on the operation conditions of the auxiliary heaters 37 and 90, the control system can be changed.

That is, when the vehicle air conditioner 1 operates the auxiliary heaters 37 and 90 under the condition where the outside air temperature is relatively high (for example, 10° C. or higher), the auxiliary heaters 37 and 90 can be operated to sufficiently satisfy the warm feeling of the passenger. In such a case, for example, in the first embodiment, when the auxiliary heaters 37 and 90 are operating, the increase in number of revolutions of the engine EG in the EV operation mode may be decreased as compared to that in the HV operation mode.

Likewise, in the second embodiment, when the auxiliary heaters 37 and 90 are operating, the decrease in driving force ratio in the EV operation mode may be reduced as that in driving force ratio in the HV operation mode. In the third embodiment, when the auxiliary heaters 37 and 90 are operating, the operation mode determined by the table of FIG. 9 is maintained, whereas when the auxiliary heaters are not operating, the operation mode may be switched into the HV operation mode.

The vehicle air conditioner 1 which operates the electric defogger under the condition where the relative humidity near the vehicle windshield W is relatively low can obtain the sufficient antifogging effect by operating the electric defogger. In such a case, for example, in the first embodiment, when the electric defogger is operating, the increase in number of revolutions of the engine EG in the EV operation mode may be decreased as compared to that in the HV operation mode.

Likewise, in the second embodiment, when the electric defogger is operating, the decrease in driving force ratio in the EV operation mode may be reduced as compared to that in the HV operation mode. In the third embodiment, when the electric defogger is operating, the operation mode determined by the table of FIG. 9 may be maintained, whereas when the electric defogger is not operating, the operation mode may be switched into the HV operation mode.

(2) The above embodiments have not described the details of the driving force for traveling of the plug-in hybrid vehicle, but the vehicle air conditioner 1 of the invention may be applied to the so-called parallel-type hybrid vehicle that can be traveled by obtaining directly the driving force from both the engine EG and the electric motor for traveling.

Also, the vehicle air conditioner of the invention may be applied to the so-called serial-type hybrid vehicle which generates power using the engine EG as a driving source of the power generator 80 to store the generated power in the battery 81, and is traveled by the driving force from the electric motor for traveling operating with the power stored in the battery 81.

1. An air conditioner for a vehicle including an electric motor for traveling and an internal combustion engine as a driving source for outputting a driving force for traveling of the vehicle, the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as an operation mode for the vehicle, the air conditioner comprising:
a heater which heats air to be blown into a vehicle interior using a coolant of the internal combustion engine as a heat source; and
a request signal output device, which outputs a request signal for increasing the number of revolutions of the internal combustion engine to a driving force controller for controlling an operation of the internal combustion engine, during a heating operation of the vehicle interior,
wherein the request signal output device outputs as the request signal, a signal that makes the number of revolutions increased in the second operation mode higher than that increased in the first operation mode.

2. The air conditioner according to claim 1, further comprising
an outside air temperature detection device which detects an outside air temperature,
wherein the request signal output device outputs as the request signal, a signal that increases the number of revolutions with decreasing outside air temperature.

3. The air conditioner according to claim 1, further comprising
a target temperature setting portion for setting a target temperature of the vehicle interior by an operation of a passenger,
wherein the request signal output device outputs as the request signal, a signal that increases the number of revolutions with increasing target temperature.

4. The air conditioner according to claim 1, further comprising an auxiliary heater which increases a temperature of at least a part of a vehicle interior,
wherein the request signal output device outputs as the request signal, a signal that increases the number of revolutions when the auxiliary heater is operating, as compared to when the auxiliary heater is not operating.

5. The air conditioner according to claim 1, further comprising
an energy saving request device, which outputs an energy saving request signal for requesting energy saving of power required for air conditioning of the vehicle interior, by an operation of the passenger,
wherein the request signal output device outputs as the request signal, a signal that decreases the number of revolutions when the energy saving request signal is output, as compared to when the energy saving request signal is not output.

6. An air conditioner for a vehicle including an electric motor for traveling and an internal combustion engine as a driving source for outputting a driving force for traveling of the vehicle, the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as the operation mode for the vehicle, the air conditioner comprising:
a heater which heats air to be blown into a vehicle interior using a coolant of the internal combustion engine as a heat source; and
a request signal output device, which outputs a request signal for decreasing a driving force ratio of the internal combustion engine-side driving force to the motor-side driving force, to a driving force controller for controlling operations of the internal combustion engine and the electric motor for traveling, when a heating operation of the vehicle interior is performed in the second operation mode.

7. The air conditioner according to claim 6, further comprising
an outside air temperature detection device which detects an outside air temperature,
wherein the request signal output device outputs as the request signal, a signal that decreases the driving force ratio with decreasing outside air temperature.

8. The air conditioner according to claim 6, further comprising
a target temperature setting portion for setting a target temperature of the vehicle interior by an operation of a passenger,
wherein the request signal output device outputs as the request signal, a signal that decreases the driving force ratio with increasing target temperature.

9. The air conditioner according to claim 6, further comprising
an auxiliary heater which increases a temperature of at least a part of a vehicle interior,
wherein the request signal output device outputs as the request signal, a signal that decreases the driving force ratio when the auxiliary heater is operating, as compared to when the auxiliary heater is not operating.

10. The air conditioner according to claim 6, further comprising
an energy saving request device, which outputs an energy saving request signal for requesting energy saving of power required for air conditioning of the vehicle interior, by an operation of the passenger,
wherein the request signal output device outputs as the request signal, a signal that increases the driving force ratio when the energy saving request signal is output, as compared to when the energy saving request signal is not output.

11. An air conditioner for a vehicle including an electric motor for traveling and an internal combustion engine as a driving source for outputting a driving force for traveling of the vehicle, the vehicle having a first operation mode in which an internal combustion engine-side driving force output from the internal combustion engine is more than a motor-side driving force output from the electric motor for traveling, and a second operation mode in which the motor-side driving force is more than the internal combustion engine-side driving force, as the operation mode for the vehicle, the air conditioner comprising:
a heater which heats air to be blown into a vehicle interior using a coolant of the internal combustion engine as a heat source; and
a request signal output device, which outputs a request signal for requesting a driving force controller to perform switching into the first operation mode when a predetermined condition is satisfied during a heating operation of the vehicle interior in the second operation mode, the driving force controller being adapted to control operations of the internal combustion engine and the electric motor for traveling.

12. The air conditioner according to claim 11, further comprising
an outside air temperature detection device which detects an outside air temperature,
wherein the predetermined condition is determined to be satisfied when the outside air temperature becomes equal to or less than a predetermined reference outside air temperature.

13. The air conditioner according to claim 11, further comprising
a target temperature setting portion for setting a target temperature of the vehicle interior by an operation of the passenger,
wherein the predetermined condition is determined to be satisfied when the target temperature is equal to or more than a predetermined reference target temperature.

14. The air conditioner according to claim 11, further comprising
an auxiliary heater which increases a temperature of at least a part of a vehicle interior,
wherein the predetermined condition is determined to be satisfied when the auxiliary heater is operating.

15. The air conditioner according to claim 11 further comprising
an energy saving request device, which outputs an energy saving request signal for requesting energy saving of power required for air conditioning of the vehicle interior, by an operation of the passenger,
wherein the predetermined condition is determined to be satisfied when the energy saving request signal is not output.

16. The air conditioner according to claim 11, further comprising
a humidity detection device which detects a humidity near a windshield of the vehicle,
wherein the predetermined condition is determined to be satisfied when the humidity detected by the humidity detection device is equal to or more than the predetermined reference humidity.

17. The air conditioner according to claim 11, further comprising
an air outlet mode switching portion for switching between a plurality of air outlet modes by changing a ratio of volumes of air blown from a plurality of air outlets between the air outlets, the air outlets including at least a defroster air outlet for blowing the air toward a windshield of the vehicle,
wherein the predetermined condition is determined to be satisfied when the air outlet mode switching portion performs switching into the defroster mode for blowing out the air from the defroster air outlet.

18. The air conditioner according to claim 4, wherein the auxiliary heater is a seat heater for increasing a temperature of a seat where the passenger sits.

19. The air conditioner according to claim 4, wherein the auxiliary heater is a windshield heating device for heating the windshield of the vehicle.
